(19) United States
(12) Patent Application Publication
(10) Pub. No.: US 2026/0303882 A1
(43) Pub. Date: Oct. 1, 2026

(54) DYNAMIC AD INSERTION

(71) Applicant: One Media, LLC, Cockeysville, MD (US)

(72) Inventors: Sangsu KIM, Owings Mills, MD (US); Liam Riley POWER, New Freedom, PA (US); Nicholas HOTTINGER, Parkville, MD (US)

(73) Assignee: One Media, LLC, Cockeysville, MD (US)

(21) Appl. No.: 19/577,106

(22) Filed: Mar. 24, 2026

Related U.S. Application Data
(60) Provisional application No. 63/777,288, filed on Mar. 25, 2025.

(51) Int. Cl. H04N 21/234; H04L 65/70; H04N 21/2187

(52) U.S. Cl. CPC H04N 21/23424; H04L 65/70; H04N 21/2187

(57) ABSTRACT

Over-the-Air (OTA) advertising lacks features provided by its Over-the-Top (OTT) counterpart due to the one-way nature of OTA advertising. Introducing the Advanced Television Systems Committee (ATSC) 3.0 standard and its approach to broadcasting information utilizing the Internet Protocol (IP) narrows the gap between the two environments. While there are similarities in the mechanisms to create regionally addressable advertisements through OTT and OTA (utilizing the ATSC 3.0 standard), they are not identical, primarily due to the latter being a one-way broadcasting system. This disclosure introduces two potential solutions to provide targeted advertising through the timely insertion of advertisements into live TV programs and an optimized dynamic ad insertion. 26545021.3

### CROSS REFERENCES

This application claims the benefit of U.S. Provisional Application No. 63/777,288 filed Mar. 25, 2025, titled “DYNAMIC AD INSERTION,” the content of which is herein incorporated by reference in its entirety.

### BACKGROUND

The described aspects generally relate to advertisement insertion in a broadcasting system.

### SUMMARY

Some aspects of this disclosure relate to an advanced television systems committee (ATSC) apparatus configured to implement dynamic advertisement insertion. The ATSC apparatus comprises a transceiver configured to enable communications with data distribution platform and a receiving device configured to receive broadcast content and a processor, communicatively coupled to the transceiver. The processor is configured to receive, from the data distribution platform, advertisement data, generate a first set of media processing units (MPUs) that includes the advertisement data, generate DASH segments based on the MPUs, and transmit the DASH segments using a real-time object delivery over unidirectional transport (ROUTE) protocol to the receiving device. The processor is further configured to generate a second set of MPUs that includes live media stream corresponding to the broadcast content, generate MPEG media transport (MMT) packets that include the second set of MPUs and one or more markers corresponding to the advertisement data, and transmit the MMT packets using a MPEG media transport protocol (MMTP) to the receiving device. The processor is further configured to transmit the DASH segments prior to transmitting the MMT packets. The one or more markers indicate when to insert the advertisement data into the live media stream.

Some aspects of this disclosure relate to a method of dynamic ad insertion. The method comprises receiving, from a data distribution platform, advertisement data, generating a first set of media processing units (MPUs) that includes the advertisement data, generating DASH segments based on the MPUs, and transmitting the DASH segments using a real-time object delivery over unidirectional transport (ROUTE) protocol to a receiving device. The method further comprises generating a second set of MPUs that includes live media stream corresponding to broadcast program content, generating MPEG media transport (MMT) packets that include the second set of MPUs and one or more markers corresponding to the advertisement data, and transmitting the MMT packets using a MPEG media transport protocol (MMTP) to the receiving device. The method further comprises transmitting the DASH segments is prior to transmitting the MMT packets. The one or more markers indicate when to insert the advertisement data into the live media stream.

Some aspects of this disclosure relate to a non-transitory computer-readable device having instructions stored thereon that, when executed by at least one computing device, cause the at least one computing device to perform operations. The operations comprise receiving, from a data distribution platform, advertisement data, generating a first set of media processing units (MPUs) that includes the advertisement data, generating DASH segments based on the MPUs, and transmitting the DASH segments using a real-time object delivery over unidirectional transport (ROUTE) protocol to a receiving device. The operations further comprise generating a second set of MPUs that includes live media stream corresponding to broadcast program content, generating MPEG media transport (MMT) packets that include the second set of MPUs and one or more markers corresponding to the advertisement data, and transmitting the MMT packets using a MPEG media transport protocol (MMTP) to the receiving device. The operations further comprise transmitting the DASH segments is prior to transmitting the MMT packets. The one or more markers indicate when to insert the advertisement data into the live media stream.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example layered structure of MPEG Media Transport (MMT), according to aspects of the disclosure.

FIG. 2 illustrates an example process of a receiver using MMT signaling to discover and display MMTP packets, according to aspects of the disclosure.

FIG. 3 illustrates an example process of obtaining type and location information of locally stored assets for replacement advertisements, according to aspects of the disclosure.

FIG. 4 illustrates an example of an ATSC 3.0 message, according to aspects of the disclosure.

FIG. 5 illustrates an example application event information (AEI) document, according to aspects of the disclosure.

FIG. 6 illustrates an example structure of an inband event descriptor (IED) table, according to aspects of the disclosure.

FIG. 7 illustrates an example structure of an ‘evti’ box used in an MMT media file format, according to aspects of the disclosure.

FIG. 8 illustrates an example placement of an ‘evti’ box within an ISO Base Media File Format (ISO BMFF) media file, according to aspects of the disclosure.

FIG. 9 illustrates an example experimental test environment, according to aspects of the disclosure.

FIG. 10 illustrates an example content identification, according to aspects of the disclosure.

FIG. 11 illustrates an example file distribution schedule, according to aspects of the disclosure.

FIG. 12 illustrates example Distribution Window Description (DWD) parameters, according to aspects of the disclosure.

FIG. 13 illustrates an example configuration interface for selecting designated market areas (DMAs), according to aspects of the disclosure.

FIG. 14 illustrates an example scheduler configuration, according to aspects of the disclosure.

FIG. 15 illustrates an example download page available on HomeCasters, according to aspects of the disclosure.

FIG. 16 illustrates an example advertisement assembly process for broadcast television systems, according to aspects of the disclosure.

FIG. 17 illustrates an example advertisement assembly process for programmatic systems, according to aspects of the disclosure.

FIG. 18 illustrates an example DASH media presentation description (MPD), according to aspects of the disclosure.

FIG. 19 illustrates an example workflow for advertisement insertion using XML linking (XLink), according to aspects of the disclosure.

FIG. 20 illustrates an example connected device workflow for dynamic advertisement insertion, according to aspects of the disclosure.

FIG. 21 illustrates an example segment splicing for event periods, according to aspects of the disclosure.

FIG. 22 illustrates an example receiver section workflow, according to aspects of the disclosure.

FIG. 23 illustrates an example broadcast application (BA) component of the system, according to aspects of the disclosure.

FIG. 24 illustrates an example sequence of operations for inserting multiple advertisements, according to aspects of the disclosure.

FIG. 25 illustrates an example comparison of resource usage between the two delivery solutions, according to aspects of the disclosure.

FIG. 26 illustrates an example sequence for the parallel advertisement workflow, according to aspects of the disclosure.

FIG. 27 illustrates an example metadata file from a pilot, according to aspects of the disclosure.

FIG. 28 illustrates an example workflow for broadcast-only advertisement insertion, according to aspects of the disclosure.

FIG. 29 illustrates an example test to validate the presence of APIs and workflow validation, according to aspects of the disclosure.

FIG. 30 illustrates an example timing possibilities validation, according to aspects of the disclosure.

FIG. 31 illustrates an example codecs in the receiver media players (RMPs) of common receivers, according to aspects of the disclosure.

FIG. 32 illustrates an example chart of a video ad serving templates (VAST) conversion, according to aspects of the disclosure.

FIG. 33 illustrates an example method of advertisement insertion, according to aspects of the disclosure.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The present disclosure includes two parts: (1) Dynamic Ad Insertion (DAI) within the ATSC 3.0 framework using MPEG Media Transport (MMT) and (2) Optimizing DAI for ATSC 3.0 in Low Broadband Access Markets.

### DAI Within the ATSC 3.0 Framework Using MMT

In some aspects, Over-the-Air (OTA) advertising lacks features provided by its Over-the-Top (OTT) counterpart due to the one-way nature of OTA advertising. Introducing the Advanced Television Systems Committee (ATSC) 3.0 standard and its approach to broadcasting information utilizing the Internet Protocol (IP) narrows the gap between the two environments. While there are similarities in the mechanisms to create regionally addressable advertisements through OTT and OTA (utilizing the ATSC 3.0 standard), they are not identical, primarily due to the latter being a one-way broadcasting system. This disclosure introduces two potential solutions to provide targeted advertising through the timely insertion of advertisements into live TV programs. A Data Distribution as a Service (DDaaS) platform and the ATSC 3.0 MPEG Media Transport (MMT) protocol are also discussed, which are integral to making these solutions feasible.

### Introduction to DAI

The ATSC 3.0 standard introduces two solutions that enable broadcasters to offer advertising services with features similar to those in OTT advertising. However, both solutions require an Internet connection.

The basis of the first solution is the Server-Side Ad Insertion (SSAI) model introduced by PearlTV. This solution includes interactive advertising that utilizes video ad serving templates (VAST) and Dynamic Adaptive Streaming over HTTP (DASH) Advertisement Insertion (Ad I) specifications within the ATSC 3.0 standard.

The basis of the second solution is the Society of Cable and Telecommunication Engineers 35 (SCTE-35) standard that describes injection of messages into broadcast streams. An encoder uses these messages to generate DASH streams, accompanied by XML Linking Language (XLink) data added to the DASH manifest to connect resources.

In this disclosure, two potential Ad I solutions are presented for targeted advertising based on MMT in the ATSC 3.0 standard, which do not require connections to the Internet. This disclosure shows how to replace original advertisements in a TV program with targeted advertisements distributed by a DDaaS platform. These methods utilize MMT signaling in receivers that support the ATSC 3.0 standard. Additionally, this disclosure briefly outlines the minimum requirements for a DDaaS platform that make these solutions feasible.

In some aspects, a DDaaS platform to distribute targeted advertisements has minimum capabilities requirements. Targeted advertisement requires the distribution of advertisements based on one or more criteria. Two examples of such criteria are advertisement distribution schedules and geographical areas where contents are distributed (broadcast). To provide such capabilities, this disclosure considers employing a DDaaS platform that enables distribution of content in chosen geographical areas and at required times. This disclosure also considers Non-Real Time (NRT) files to represent the content. In this disclosure, NRT files refer to files whose contents are advertisements.

Regarding data distribution schedules, the proposed Ad I methods in this disclosure require the content to be available to receivers before the Ad I process starts. Therefore, a DDaaS platform provides capabilities to enable timely content distribution. The following parameters can be considered for this purpose:
Distribution (Broadcast) Time: The time of the day during which the content distribution (broadcast) sessions will start and end.
Repeats: The number of times necessary to broadcast the content during distribution time.
Recurrence: The frequency of the distribution of the content over days.
Range of Recurrence: The period during which the content distribution will occur.

Distribution Time provides broadcasters with flexibility to decide when to broadcast the content. The Distribution Time is important because, in a DDaaS platform, resources used to distribute content may not be available during certain times, for example, when fulfilling other data distribution requests.

Recurrence, Repeats, and Range of Recurrence indicate on which days and how often content distribution will occur, respectively. At first glance, these parameters may seem redundant. One might assume that a one-time content distribution should be enough to deliver the content to receivers. However, such a design cannot guarantee content availability to all receivers at the proper time (before the Ad I process starts). Some receivers may not be available to receive the content when the broadcast session starts. A mechanism to help with this scenario is discussed below.

Regarding data distribution areas, broadcasters will be able to limit content distribution to specific geographical areas. A DDaaS platform can achieve this by providing tools that allow broadcasters to choose one or more Designated Market Areas (DMAs). While broadcasters are traditionally familiar with DMAs, a DDaaS platform may consider more granular identifiers such as postal and county codes. If such identifiers are considered, mechanisms to configure receivers to receive relevant content can also be implemented.

Regarding advertisement identifiers, Ad I uses additional information: Asset ID and Advertisement Time(s). Asset ID is an identifier that uniquely identifies an advertisement. Advertisement Time indicates the actual time at which an advertisement can be displayed. When modeling content distribution, a DDaaS platform will also collect this additional information, which can be broadcast.

In some aspects, MMT is a standard for transporting multimedia data developed by the Moving Picture Experts Group (MPEG). It is a fully developed standard that provides encapsulation, delivery, and presentation of multimedia content, enabling hybrid (broadcast and broadband) content delivery through IP packets. MMT supports essential features such as Quality of Service (QoS) and efficient Forward Error Correction (FEC). MMT specifications are primarily defined in three parts: 1) MPEG-MMT Part 1 (MMT, ISO/IEC 23008-1), 2) Part 10 Forward Error Correction (FEC, ISO/IEC 23008-10) Codes, and 3) Part 11 Composition Information (CI, ISO/IEC 23008-11)—part 1 mainly concerns encapsulation methods, signaling, and delivery mechanisms. This disclosure briefly describes important concepts of MMT.

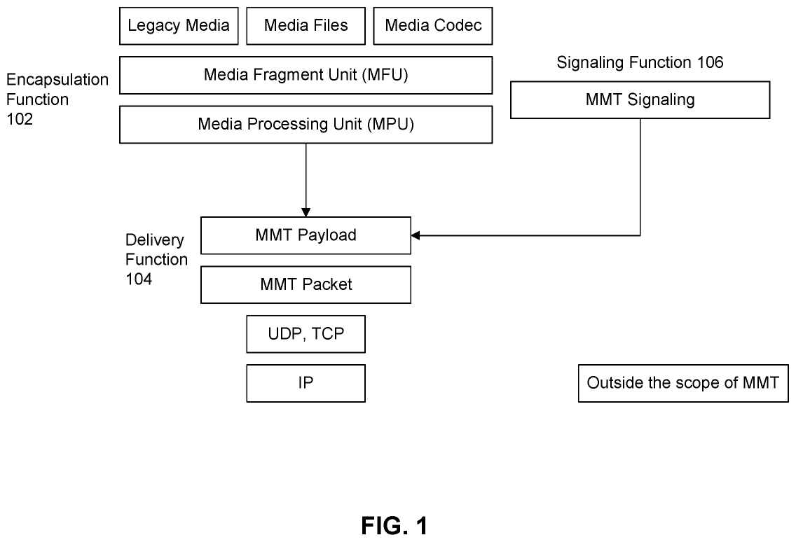

FIG. 1 illustrates an example layered structure of MPEG Media Transport (MMT), according to aspects of the disclosure. Regarding MMT fragmentation, MMT Part 1 defines the structure of the multiple media content ready to be fragmented (packetized) for streaming or progressive download. FIG. 1 shows the layered structure of MMT that is used for controlling the transportation and consumption of the fragments. This structure is concerned with encapsulating (Encapsulation Function) 102, content delivery (Delivery Function) 104, and signaling (Signaling Function) 106.

Encapsulation Function (EF) 102 in MMT defines the logical structure of the content and introduces the concepts of Asset and Media Processing Unit (MPU) format. The content structure is based on different asset types corresponding to each elementary stream, such as video, audio, and subtitles. An Asset is a logical group of MPUs with the same Asset Identifier (Asset ID) for carrying encoded media data. Encoded media data can include timed media, such as MPEG-2 TS and MP4 files, and non-timed media, such as web pages, texts, and pictures. Each asset has an Asset ID, which can be represented, for example, with a Uniform Resource Identifier (URI) or a Universally Unique Identifier (UUID). An MMT package is a collection of one or more Assets, and an ATSC 3.0 Service can include one or more MMT packages.

An MPU is a self-decodable and self-rendering media unit structured based on the ISO Base Media File Format (ISOBMFF), an MPEG standard primarily intended for timing media data such as audio and video. MPUs in an Asset are distinguished by sequence numbers and do not overlap on the timeline. When these MPUs are delivered through MPEG Media Transport Protocol (MMTP), they are separated into small segments named Media Fragment Unit (MFU), which usually consists of one Access Unit (AU) or part of an AU.

Delivery Function (DF) 104 in MMT has three modes: 1) MPU, 2) Generic File Delivery (GFD), and 3) Signaling Message. MPU mode is for transporting MPUs and can be used for real-time services such as broadcast and streaming. GFD mode is used for download services and is the counterpart of the NRT service in the MPEG-2 TS system. Signaling Message mode is for exchanging signaling messages through MMTP.

ATSC 3.0 introduced the Real-Time Object Delivery over Unidirectional Transport (ROUTE) protocol for NRT object delivery. ROUTE works with MPEG-DASH-based segments. MMTP and ROUTE packets are delivered through User Datagram Protocol (UDP), while broadband Transmission Control Protocol (TCP) is used.

Signaling Function (SF) 106 in MMT specifies signaling messages that provide information about media consumption and delivery to receivers. These messages can be delivered in a payload of an MMTP packet and are multiplexed with other media packets.

There are five main messages defined in the MMT standard as follows:
Package Access (PA) message: This message includes various information about a Package.
Media Presentation Information (MPI) message includes Composition Information (CI).
MMT Package Table (MPT) message: This message includes information about assets in a Package.
Device Capability Information (DCI) message includes device capability information.
Clock Relation Information (CRI) message: This message includes mapping information of Network Time Protocol (NTP) timestamps and System Time Clock (STC) of MPEG-2 TS.

MMT includes other messages defined in Amendment ISO/IEC 23008-1.

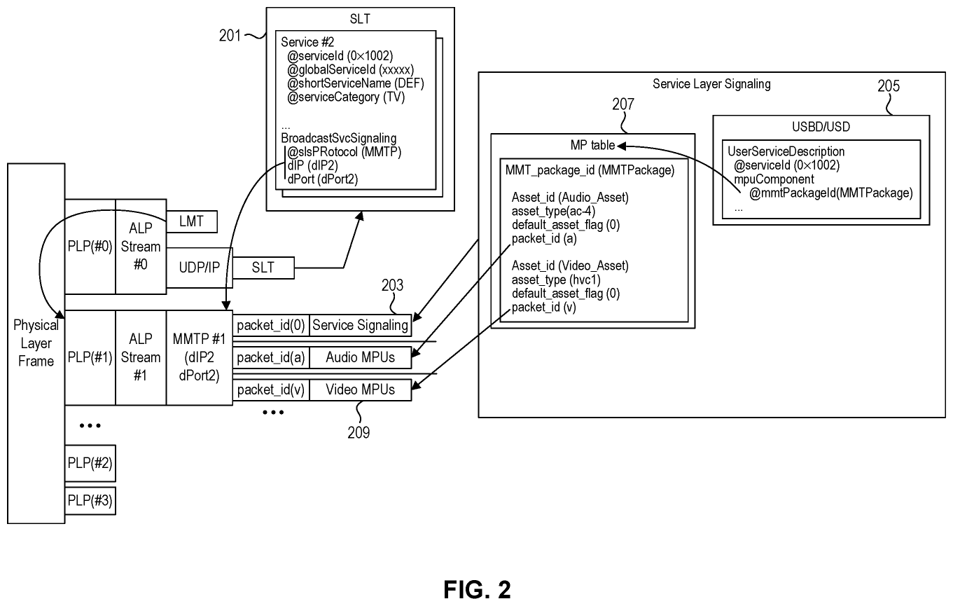

FIG. 2 illustrates an example process of a receiver using MMT signaling to discover and display MMTP packets, according to aspects of the disclosure. Regarding MMT reception, FIG. 2 provides detailed information on how a receiver uses MMT signaling to discover and display MMTP packets.

A receiver accesses a stream containing low-level signaling (LLS) data using a predefined IP address (224.0.23.60) and port number (4937) first. LLS data includes a Service List Table (SLT) 201 that provides information about the desired broadcasting service. More specifically, SLT supports a rapid channel scan that enables the receiver to build a list of all ATSC 3.0 services. SLT also provides bootstrap information that allows the receiver to locate Service Layer Signaling (SLS). This bootstrap information contains the destination IP address, port number, and the MMTP session that carries SLS for services delivered via MMTP/MPU. MMTP and ROUTE sessions are identified in the same way. MMTP includes the destination IP address, port number, and packet_id (a unique identifier).

Before acquiring the delivered content from broadcasters, the receiver parses SLS 203 SLS comprises XML-based User Service Description (USD) 205 and MPT fragments. SLS describes the characteristics of a service, its content components, where to acquire them, and the device capabilities needed to present the service meaningfully. USD mainly references the MMT Package Table (MPT) 207 message in MMT signaling. MPT provides identification of package ID and location information for assets belonging to the service. MMTP delivers MMT signaling messages according to the signaling message mode. The MPT extracted from the message is processed to get the list of MMT assets comprising a selected service with the designated MMT ‘packet_id’. Finally, the first Access Unit (AU) in an MPU from the selected asset 209 is decoded by the appropriate decoder and presented at the time specified by the ‘MPU_timestamp’.

### Overview of How to Replace an Original Advertisement

In this section, this disclosure provides an overview of an approach to replace the original advertisements (those already included in a live TV program) with targeted advertisements in real-time using the DDaaS platform and MMT. In later sections, specific methods to implement Ad I are discussed.

This disclosure includes a Client-Side Ad Insertion method (CCAI) to replace the original advertisement. This method fills predefined advertisement time slots with targeted advertisements already delivered to the receivers. Initially, the DDaaS platform distributes regionally targeted NRT files containing advertisements to receivers, which receive and cache them. During the processing of live MMT streams, when an advertisement marker (indicating the start of an advertisement) is encountered, the player requests the corresponding advertisement using its Asset ID from the receiver. The receiver responds to the request by providing the cached advertisement, which the player uses to fill the time slot for the advertisement. The basic steps are:
1. An advertisement marker in the MMT stream indicates when the player will pause the live TV stream playback and switch to new content.
2. The player requests an advertisement previously delivered through broadcast and stored on the receiver.
3. The receiver responds with the designated advertisement.
4. The player pauses the playback of the MMT stream and plays the advertisement.
5. Once the advertisement is complete, the playback of the MMT stream resumes.

The DDaaS platform offers a broadcast network for delivering advertisements. Advertisements configured through the DDaaS platform are broadcast as NRT files via the Broadcast Gateway (Scheduler) and received by receivers. The ATSC 3.0 Broadcast Gateway (BG) supports LLS, ROUTE, MMT, Electronic Service Guide (ESG), and NRT delivery.

Receivers receive the broadcast, which includes MMTP packets. These packets are de-packetized, and the appropriate media decoders decode the encapsulated media data. Advertisements are delivered as NRT files through ROUTE. In order to receive the NRT files, the receiver can be provided with the Extended File Delivery Table (EFDT), which includes files metadata. A delivered file references the Layered Coding Transport (LCT) session and its URI. File URIs are used to identify the delivered EFDT, and the receiver uses the EFDT to process NRT content.

Regarding advertisement file format, files containing advertisements can be DASH segments, including Media Presentation Description (MPD). The creation of DASH segments is achieved by encapsulating MPUs into DASH segments.

Regarding generating advertisement markers, BGs broadcast advertisements according to data distribution schedules and generate markers in the MPT to signal the replacement of advertisements in live MMT streams. These markers are part of the MPT table and contain Asset location information and presentation time. The BG checks whether the asset included in the live MMT stream matches the Asset ID of the advertisement created in the DDaaS platform. If there is a match, the BG updates the information in the MPT table from the live asset to the advertisement information.

Regarding service allocation to deliver NRT files, at a minimum, one service with proper signaling can be created (or available) to deliver NRT files. ATSC 3.0 standard documentation A/331 (Signaling, Delivery, Synchronization, and Error Protection) specifies different file delivery methods. The methods should not impact the existing broadcast (media) services:
Using a dedicated ROUTE session that could be HIDDEN,
Using a private service (User Defined Service with LLS table ID 0xFF).

Regarding Distribution Window Description (DWD), DWD is thoroughly defined. Using DWD, NRT file delivery schedules can be communicated to receivers before broadcast time. DWD includes an “indication of the specific files that will be transmitted during a given distribution window”. Receivers can use this information to plan for their availability when NRT files are broadcast. One method is to broadcast it multiple times to ensure that a file is delivered in its entirety. The above requirement is essential when a receiver is already tuned to a different service during a distribution window; with this method, the receiver can receive the file during the later broadcast sessions.

In order to ensure that receivers process NRT files of interest, such as advertisements designed for specific postal codes, the receiver can use two pieces of information, AppContextID and Filter Codes, included in DWD. Each distribution window instance can include one or more AppContextID elements, which may contain one or more Filter Codes. Filter Codes are 32-bit unsigned integers and are unique within the context of their corresponding AppContextID instance.

In some aspects, information about receiver operations and requirements for Ad I operations is as following. Regarding operations, when switching from an MPU to a DASH segment, the player in a receiver uses the latest MPD contained in an MPT message to make a local request for a DASH segment before the transition. The received DASH segment is buffered in advance and made available to the player for decoding. It is important to note that the DASH segment and MPU can have the same video/audio format.

Regarding tuning, in order to receive advertisements, a receiver can tune into one or more broadcast channels used for NRT file distribution. The above can be accomplished by performing a channel scan to search for fingerprints and identifying which advertisements to accept. Fingerprints can be specific AppContextId and Filter Codes, for example.

Regarding file management, advertisement files are received and stored on file systems. Receivers can use the information in the DWD and similar information at the Service, Session, and Object levels to filter which files to accept. Eligible files are received and stored on storage available to the receiver. However, the information used to accept or ignore files does not provide the control needed to manage the storage. In order to manage the storage, the following functionalities are necessary:
Cache Management: Manage the cache when the content exceeds the available size.
File Management: Remove NRT files that are no longer required or have timed out from the local cache.
Cache Miss Management: Implement a fallback method for obtaining NRT files if they are not saved in the local cache when requested.
Cache Population: Instruct the receiver to store received NRT files from ROUTE sessions.
Content Download: Receive the required NRT files, potentially requiring re-tuning the receiver at a specific time when it is not used for other purposes.
To provide necessary metadata for advertisements, include the following information:
   Asset ID: Unique identifier for the advertisement.
   Name: Name or title of the advertisement.
   Received Time: Time when the receiver received the advertisement.
   Complete/Incomplete: Indicates whether the advertisement was received entirely or incompletely.
   Size: Size of the advertisement file.
   Duration: Length of the advertisement in seconds.
   File Signature (MD5/SHA256 Hash): Has value to verify the integrity of the advertisement file.
   Validity Start Time: Start time for the validity of the advertisement.
   Validity End Time: End time of the validity of the advertisement.
   Application Context ID: Identifier for the application context related to the advertisement.
   Filter Codes: Codes are used to filter and select specific advertisements.
   Content type: Type of content (e.g., video, audio, image).
   Content Location in the Cache (URI): URI points to the location of the advertisement in the local cache.
      This metadata can be used for managing, tracking, and displaying advertisements in the broadcast system

Regarding file access and media playout, receivers are required to support a lightweight web server that enables a file consumer to access the files through the HTTP protocol. The application running on a receiver uses this capability to access the files that are accepted and stored on the storage.

In addition to playing live broadcast content, a receiver will be able to play out NRT advertisement files stored in the cache. This capability is also provided through the lightweight web server, which can be viewed as localized mini-Content Delivery Network (CDN) in conjunction with the storage.

Regarding standby/wakeup behavior, when receivers are not actively functioning, for example, videos are not being played, they will support a Standby mode so they can still become available to receive new data. In other words, the Standby mode provides a Wakeup mechanism to allow for receiving new data, according to some previously provided information, such as information provided through DWD.

### Advertisement Replacement

This section describes two methods for replacing live TV advertisements transmitted through MMT with advertisements distributed by the DDaaS platform.

### Advertisement Replacement by Using MMT Package Table

This section provides a short background on how a TV program is received. Then, this disclosure describes proposed advertisement replacement method.

Regarding MMT Package Table in the live MMT Stream, the process of receiving and rendering media components in MMT-based broadcasting systems is as follows:
Identification: The receiver identifies MMTP packets carrying MPUs through MFUs.
Decoding: The receiver decodes the received MFUs to extract the media data.
Rendering: The decoded media data is rendered at the designated time, allowing viewers to watch the desired TV program.

An Asset represents a media component equivalent to a series of MPUs. In MMT-based broadcasting systems, a TV program is an MMT Package, which includes one or more Assets and the corresponding signaling information. A Package Access Message (PAM) is an MMT-Service Information (MMT-SI). The MPT included in the PAM identifies the Assets that make up a TV program. In order to retrieve the PAM, a receiver will look for MMTP packets with ‘packet_id’ equal to zero (‘packet_id=0’). Receivers parse the PAM to extract the MPT.

A receiver uses the MPT to identify packet_ids of MMTP packets that carry a TV program's required MPUs (parts of the asset). Additionally, it obtains the display time of the MPU by referring to the MPU Timestamp Descriptor included in the MPT.

Multiple services might be multiplexed into one IP data flow. Therefore, the receiver will verify whether the ‘packet_id’ of the acquired MPT corresponds to the desired ‘service_id.’ If there is a mismatch, the receiver will acquire the Package List Table (PLT) included in PAM. The PLT provides information corresponding to the MPT of the desired service.

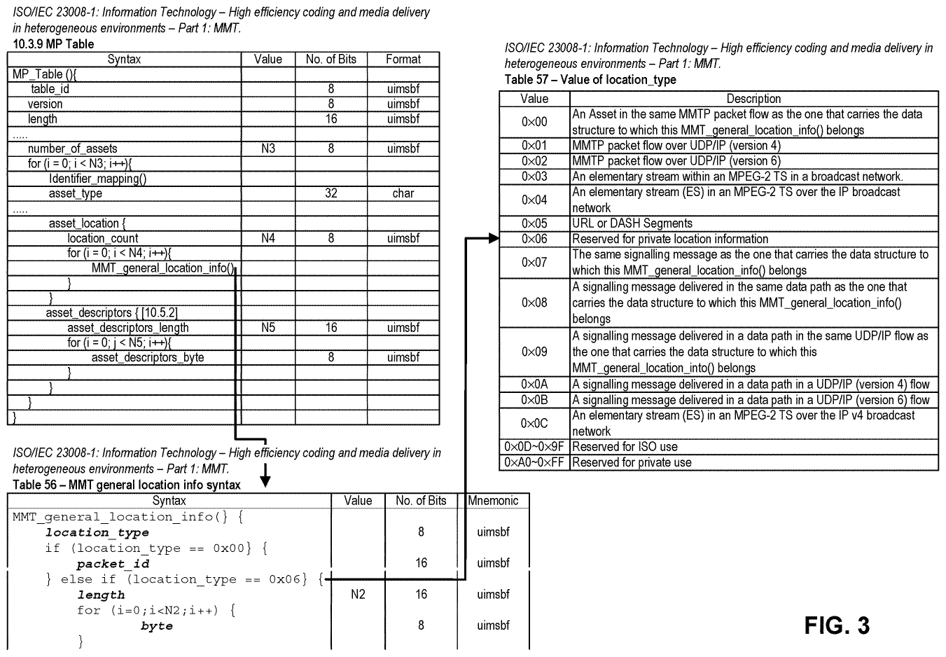

FIG. 3 illustrates an example process of obtaining type and location information of locally stored assets for replacement advertisements, according to aspects of the disclosure. Regarding replacing advertisements, in order to replace an Asset in a live TV program with an advertisement stored locally, the receiver requires an advertisement marker to indicate when an advertisement will be displayed. Additionally, the receiver needs information about the type and location of the locally stored asset for the replacement advertisement. FIG. 3 illustrates how this information is obtained.

The location reference information for the asset, as shown in FIG. 3, is detailed in Table 57. For Asset locations, the value of ‘location_type’ will be either ‘0x00’ or ‘0x06’. A value of ‘0x00’ indicates that an Asset is in the same MMTP packet flow as the live TV program, while ‘0x06’ indicates a private location, such as a location in the receiver's local cache.

When utilizing the MMT package table to replace the advertisement, the ‘location_type’ field is set to ‘0x06’ to specify the location of the advertisement stored in the receiver's local cache. This field's ‘byte’ value will be the URI referencing the MPD of a DASH segment containing the advertisement. The above allows the receiver to locate and retrieve the advertisement from its local cache for playback. The method to replace the advertisement involves the following steps:
1. A packet in the live MMT stream contains an Asset with a ‘location_type’ of ‘0x 06’, which serves as an advertisement marker. This marker indicates when the live stream will break from the playback and switch to the advertisement.
2. The player reads the advertisement marker and requests the receiver to retrieve an advertisement stored in the local cache using the URI indicated by the marker.
3. The receiver responds with the correct advertisement.
4. The player pauses the playback of the MMT stream and plays the advertisement.
5. Once the advertisement is finished, the playback of the MMT stream resumes.

### Advertisement Replacement by Using Event Stream

In this section, a brief background is first discussed on how Events are received, which are notifications to inform a receiver or Broadcast Application that something has changed. Then, an advertisement replacement method is discussed.

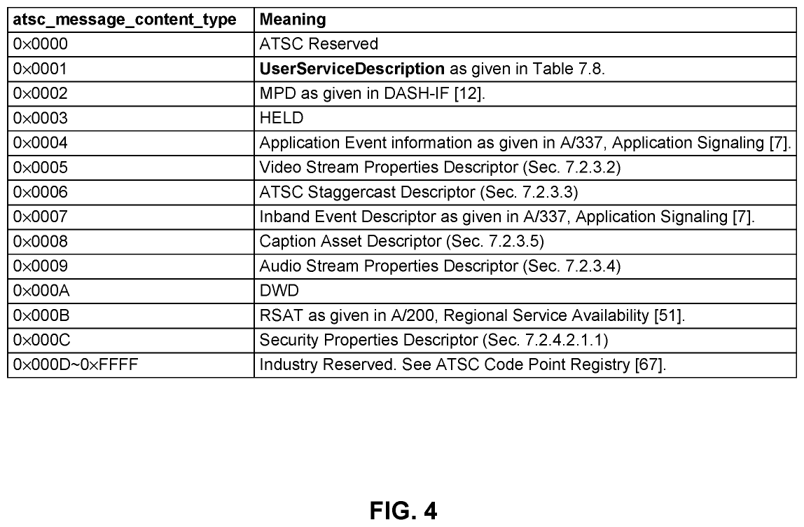

ATSC 3.0 services carried by MMTP use MMTP-specific signaling messages specified in Clause 10 of ISO/IEC 23008-1, delivered in binary format by MMTP packets according to the Signaling Message Mode specified in sub-clause 9.3.4 of ISO/IEC 23008-1. This sub-clause specifies that the value of the ‘packet_id’ field of MMTP packets carrying SLS will be set to ‘0x0000’. Additionally, another message called MMT ATSC3 (MA3) message (‘mmt_atsc3_message( )’) carries system metadata that is specific to ATSC 3.0 services such as SLS. The value assigned to ‘message_id’ for MA3 message is defined as ‘0x8100’ and each message is described in FIG. 4. FIG. 4 illustrates an example of an ATSC 3.0 message, according to aspects of the disclosure.

In this disclosure, Application Event Information (AEI) (0x0004) and Inband Event Descriptor (IED) (0x0007) are used, collectively known as Event Stream in FIG. 4. AEI and IED notify a receiver when unexpected updates to signaling metadata objects become available.

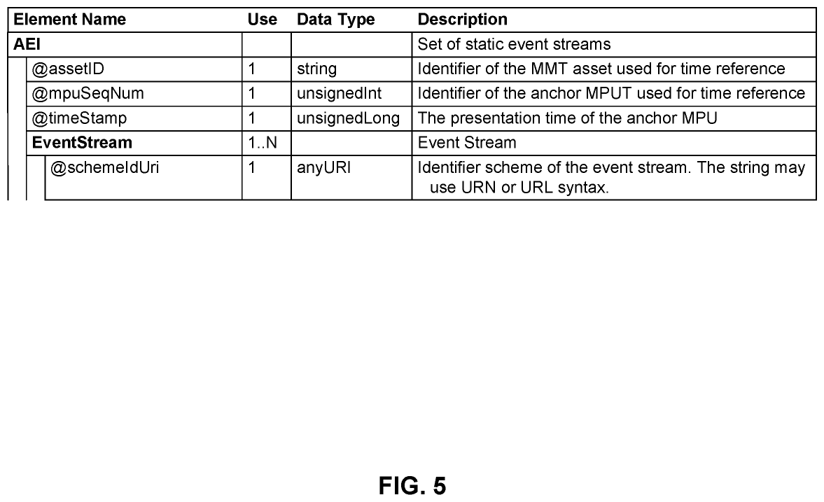

Regarding Replacing Advertisements using AEI, the EventStream element is well suited for “static” Events, i.e., Events for which the timing is known well ahead. When delivered via broadcast in an MMT-based broadcasting system, Events may be delivered in an XML document called an Application Event Information (AEI) document (FIG. 5). FIG. 5 illustrates an example application event information (AEI) document, according to aspects of the disclosure.

Each EventStream element has an ‘@assetId’ attribute and a ‘@schemeIdUri’ attribute to identify the type and location of Events with an advertisement marker in the EventStream. In order to replace an Asset in the live MMT stream with an advertisement stored in the cache, the receiver will first check whether the ‘@assetId’ is valid and whether an advertisement from the location indicated by the URI pointing to the MPD of a DASH segment is available. The steps to insert a new advertisement are:
1. A live MMT stream has an AEI, used as an advertisement marker. This marker indicates when the live stream will break from the playback and switch to the advertisement.
2. The player reads the advertisement marker and requests the receiver to retrieve an advertisement stored in the local cache using the URI indicated by ‘@schemdIdUri’.
3. The receiver responds with the proper advertisement.
4. The player pauses the playback of the MMT stream and plays the advertisement.
5. Once the advertisement is finished, the playback of the MMT stream resumes.

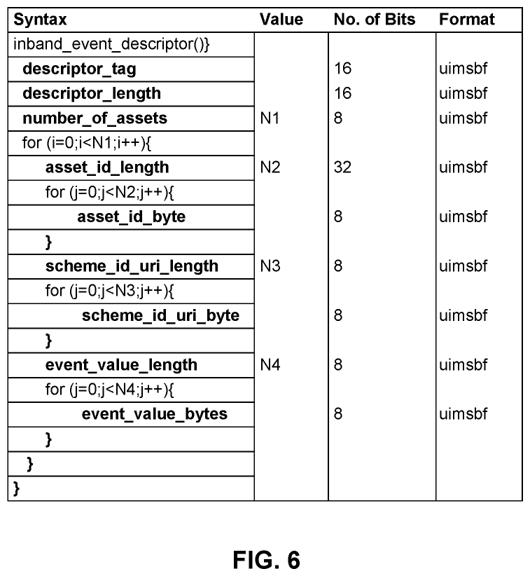

Regarding Replacing Advertisements using IED, IED indicates the presence of Events in the MPUs. The IED table (FIG. 6) contains ‘@assetId’ and ‘@schemeIdUri.’ These attributes are very similar to the AEI described in 4.2.2. FIG. 6 illustrates an example structure of an inband event descriptor (IED) table, according to aspects of the disclosure.

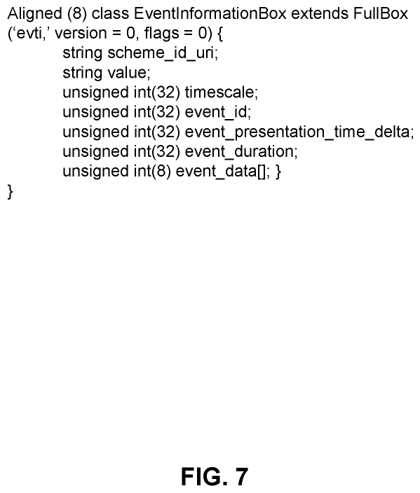

Events in MMT-based broadcasting systems can be carried in ‘evti’ boxes. Files conforming to the MMT media file format are formed as “boxes” containing all media/metadata. The “box” is an object-oriented building block defined by a unique type identifier and length. Advertisement markers in MPUs can be represented in ‘evti’ boxes. This method is particularly suitable for “dynamic” Events, i.e., Events for which the timing becomes known at the last minute. The structure of an ‘evti’ box (FIG. 7) is indicated below, using the usual specification for a box in an ISO BMFF file. FIG. 7 illustrates an example structure of an ‘evti’ box used in an MMT media file format, according to aspects of the disclosure.

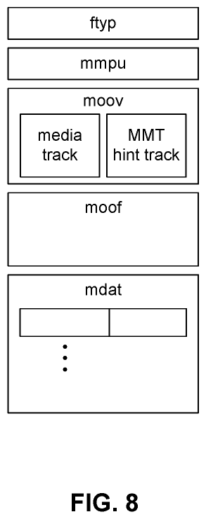

An evti box (FIG. 8) may appear at the beginning of the file, after the ‘ftyp’ box, before the ‘moov’ box, or immediately before any ‘moof’ box. FIG. 8 illustrates an example placement of an ‘evti’ box within an ISO Base Media File Format (ISO BMFF) media file, according to aspects of the disclosure.

In order to replace an Asset in the live MMT stream with an advertisement stored in the cache, the receiver will first check whether the ‘@assetId’ in IED is valid and whether an advertisement from the URI indicated by ‘scheme_id_uri’ in ‘evti’, pointing MPD of a DASH segment, is available in the local cache.

Because IED is an MMT Signaling message, it can be transmitted prior to an MMT MPU with ‘evti.’ The MMT Signaling message informs the receiver in advance that the asset in the live stream may be replaced with another advertisement. The steps to insert a new advertisement are as follows:
1. A live MMT stream has an IED, used as an advertisement marker. This marker indicates when the live stream will break from the playback and switch to the advertisement.
2. The player checks an ‘AssetID’ from IED and requests the receiver to retrieve an advertisement using ‘scheme_id_uri’ from ‘evti’ of MMT MPU. A URI points to a file in the local cache.
3. The receiver responds with the proper advertisement.
4. The player pauses the playback of the MMT stream and plays an advertisement.
5. Once the advertisement is finished, the playback of the MMT stream resumes.

Regarding replacing advertisements by a broadcast application, advertisements can also be managed and processed by a Broadcast Application (BA) rather than the receiver. The BA will use the A/344 API. Initially, the BA will utilize the subscription API (9.3.1.1 Integrated Subscribe API in A/344) to start receiving the desired notifications, such as AEI. The receiver issues the Signaling Data Change Notification to the currently executing BA if a new version of signaling data is received. The BA may respond to the notification of a change to the signaling data using the Query Signaling Data API specified in Section 9.2.10 of A/344. The receiver will continue to send subscribed notifications until the BA requests the Integrated Unsubscribe API.

The BA can proceed with the same procedure as the receiver did above with the AEI. However, advertisement playback will be delivered to the Receiver Media Player (RMP) managed by the receiver. The previous statement allows the BA to take advantage of an optimized media player provided by the receiver. The BA may use the Set RMP URL API (9.7.3 Set RMP URL API in A/344) to request the receiver to use its RMP to play the advertisement originating from a URI indicated by AEI. Once the receiver is notified to play the advertisement from the BA-provided URI, the RMP stops rendering the broadcast content and begins rendering the advertisement referenced by the new URI.

### Test Environment

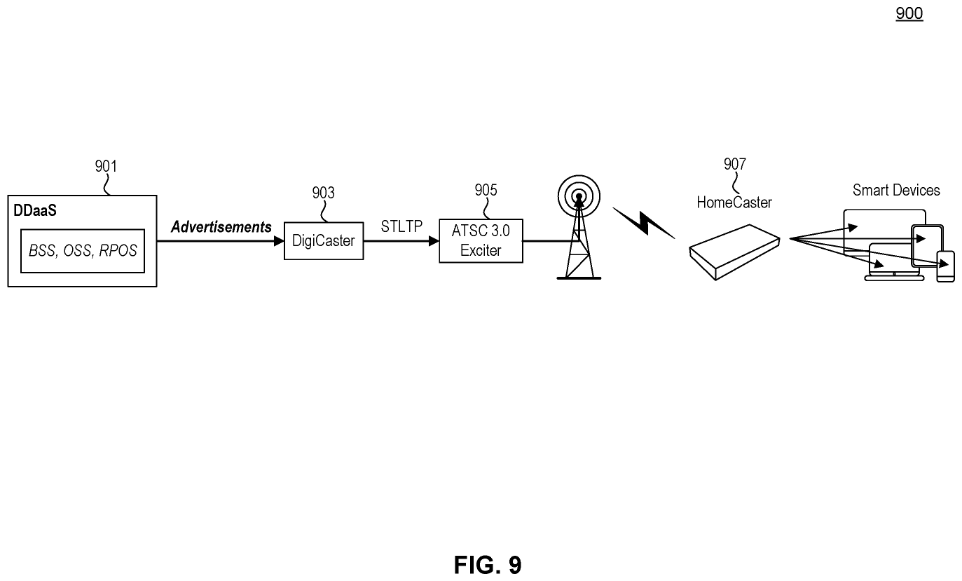

In the experiments, the test environment 900 (FIG. 9) consisted of 3 components described in this section. FIG. 9 illustrates an example experimental test environment 900, according to aspects of the disclosure.

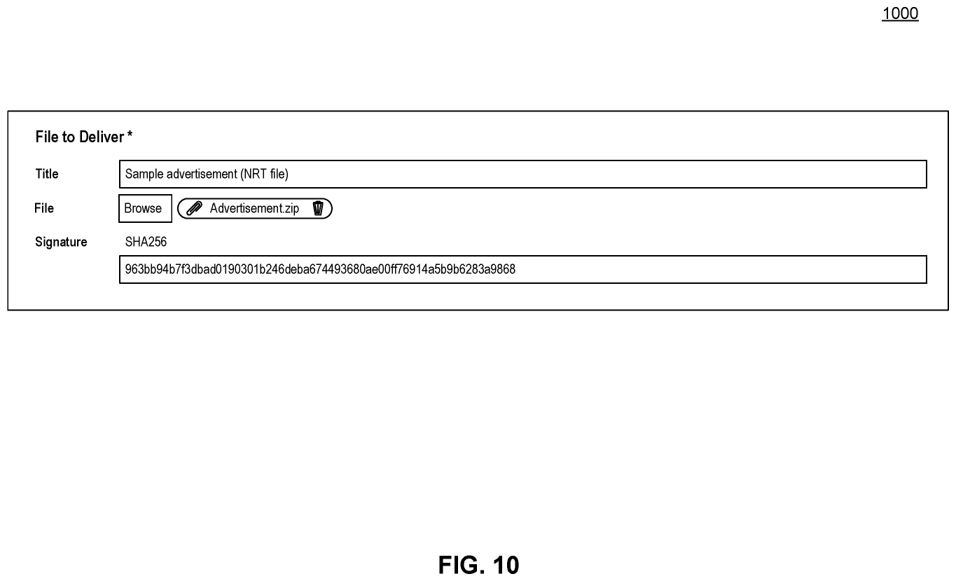

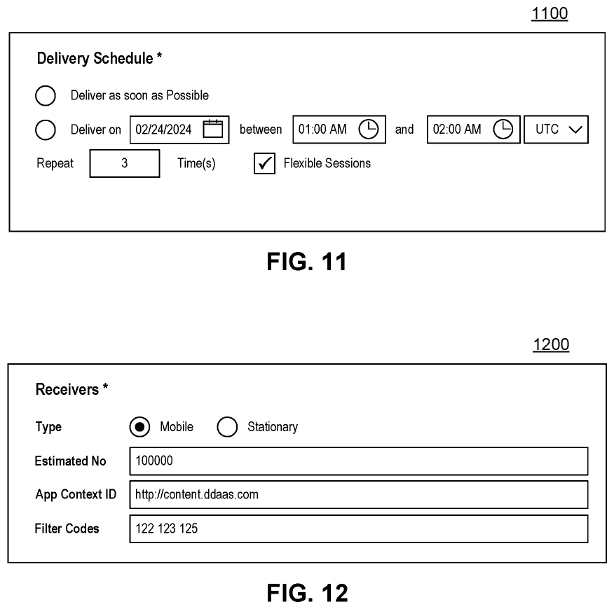

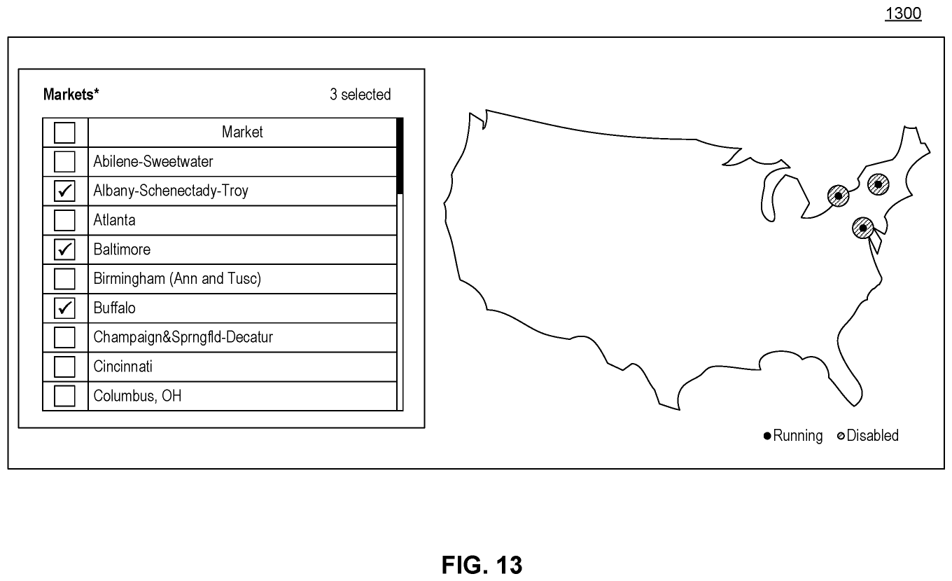

Regarding data distribution modeling using the DDaaS platform 901, to model the distribution of NRT files corresponding to advertisements, the DDaaS platform is used. This platform enables seamless specifying the content, time, and DMAs for experimental advertisements. FIGS. 10-13 illustrate how data distribution requests corresponding to advertisements are modeled. For example, FIG. 10 discusses content identification 1000; FIG. 11 illustrates file distribution schedule 1100, FIG. 12 illustrates DWD related parameters 1200, and FIG. 13 illustrates DMA selection 1300.

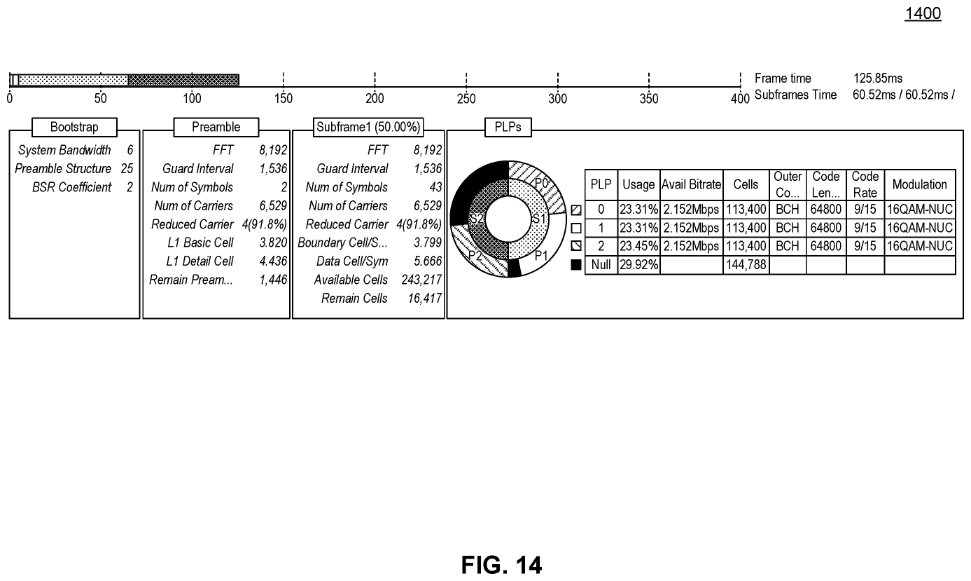

Regarding ATSC 3.0 Air chain, in the experiments, the air chain included a DigiCaster packager and a DigiCaster scheduler (collectively 903) whose output was sent to an exciter 905. Due to transmission restrictions in a lab environment, the exciter output is sent directly to the receiver 907 using, for example, antenna coax cables. FIG. 14 illustrates the scheduler's configuration 1400. FIG. 14 illustrates an example scheduler configuration, according to aspects of the disclosure.

Regarding receiver hardware, a HomeCaster, a receiver produced by DigiCAP Co., Ltd., is used to receive the broadcast content. This device includes two (2) tuners capable of receiving both ATSC 1.0 and 3.0 signals. Its primary use case is to receive ATSC 1.0 and 3.0 signals, demodulate them, and demux them into media sources. This device can be configured as a Local Area Network (LAN) node. This feature allows access to the received content through API calls supported by this device.

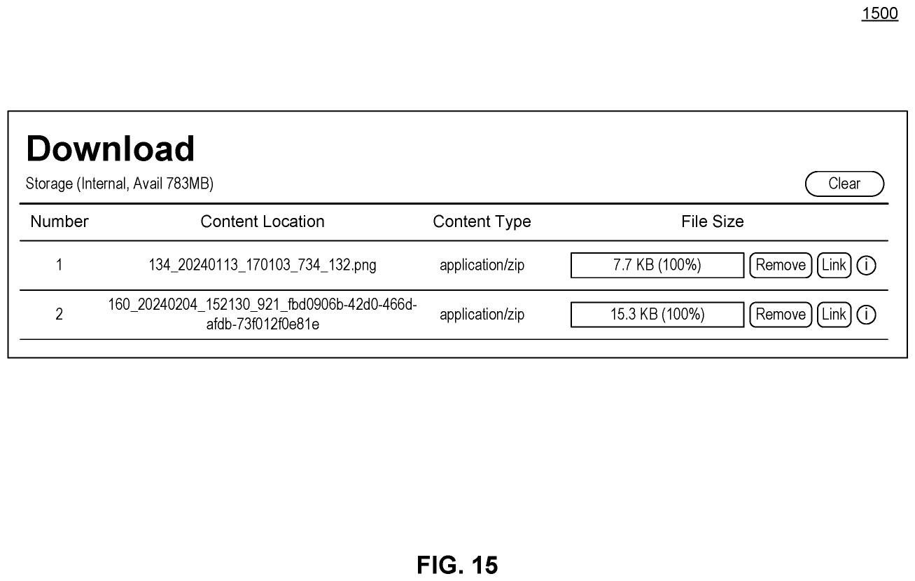

HomeCaster Middleware performs the main functions of re-transmitting media sources: RTP, UDP, HLS, and DASH. It also provides access to NRT files via an Apache HTTP server. FIG. 15 shows a snapshot 1500 of the Download page available on HomeCasters, which can be used to verify the broadcast content. FIG. 15 illustrates an example download page available on HomeCasters, according to aspects of the disclosure.

Regarding result, the experiments involved on-demand broadcasting of files ranging from 1 MB to 100 MB. Using DDaaS platform, these files are scheduled for broadcast at different times. It is confirmed that the receiver successfully received each file and verified the integrity of the files by calculating their SHA256 hash.

### Other Discussions

In some aspects, a complete AI process may be integrated into the system discussed above. Regarding the targeted content distribution, in the experiments, the DDaaS platform is used to demonstrate how advertisements can be delivered to receivers promptly for Ad I.

The advertisements transmitted from the DDaaS platform are well stored in receivers. Advertisements included in live MMT streams can be correctly replaced with stored advertisements at the appropriate times.

Regarding MMT evolution and receivers, the ATSC 3.0 specification was enhanced with additional features, including DRM and Application/Signaling Signing. This development indicates that MMT specifications have now reached a level of organization similar to ROUTE/DASH. Furthermore, MMT has gained popularity in mobility, with several projects in the 3rd Generation Partnership Project (3GPP) adopting it.

However, there are currently few receivers that fully support MMT.

Regarding Targeted Advertising in a two-way connection, the proposed Ad I solution is inexpensive, easy to introduce, and tailored for the one-way OTA environment. However, it has the disadvantage of delivering one advertisement at a time to all receivers on the same channel in a specific region. To address this, a method is proposed to provide advertising services by segmenting the entire audience into smaller groups based on viewing patterns and behavioral data, using third-party Ad-Decision solutions. Segmentation can be based on geographical criteria such as country, state, or metropolitan area and channel criteria such as genre or time.

In summary, MMT is designed to efficiently deliver multimedia content over IP networks, allowing dynamic adjustments of the content based on network conditions and device capabilities. The previous statement about MMT enables broadcasters to deliver high-quality content, including 4K UHD broadcasts, simultaneously to consumers at home and on mobile devices. MMT can also reduce real-time media encoding and channel change times at the receiver, enhancing viewers' perception of quality.

The DDaaS platform is designed to facilitate on-demand data distribution through broadcasting, supporting both NRT file distribution and streaming content applications based on the ATSC 3.0 standard.

This disclosure discusses Ad I solutions for the OTA environment using the DDaaS platform and the MMT protocol. These solutions, in conjunction with future developments, have the potential to assist broadcasters in providing services that lead to increased revenue through targeted advertising.

### Optimizing Dynamic Ad Insertion for ATSC 3.0 in Low Broadband Access Markets

This section builds on previous sections, which discussed Dynamic Ad Insertion (DAI) within the ATSC 3.0 framework using MPEG Media Transport (MMT). The current section extends this the disclosure of the previous sections by developing a robust broadcast-only transmission solution within encoder/packager systems to enable targeted ad delivery. The implementation supports precise control over ad breaks and allows for real-time event tracking by leveraging broadcaster applications, NRT data distribution, and DASH EventStream technologies. Additionally, this architecture integrates with mobile devices featuring local application storage, allowing for preloading and personalized selection of advertisements based on individual user preferences and service viewing history. Designed with the D2M (Direct-to-Mobile), this disclosure examines the requirements and solutions developed to address an environment in which all ad distribution and decision logic can be completed in a broadcast-only system, with no guarantee of broadband access.

### DAI Implementation

One of the advantages for streaming video is the ability for the services to insert advertising on a viewer-by-viewer basis, increasing the value of each avail by matching the profile of the viewer to the most relevant ad. Linear broadcast ads, on the other hand, are limited to a ‘one size fits all’ method of delivery for the most part. It is therefore important for the ATSC 3.0 standard to meet or exceed this capability for broadcast television. This is particularly challenging to implement a broadcast offload system to alleviate the immense cellular congestion in the market, as traditional internet-based methods are not viable.

Over the course of this process, refinements were made not only to the broadcast workflow, but also to the base broadband methodology. The aspects of this disclosure outlines the decision points, and the solutions developed.

### DAI Overview and Benefits

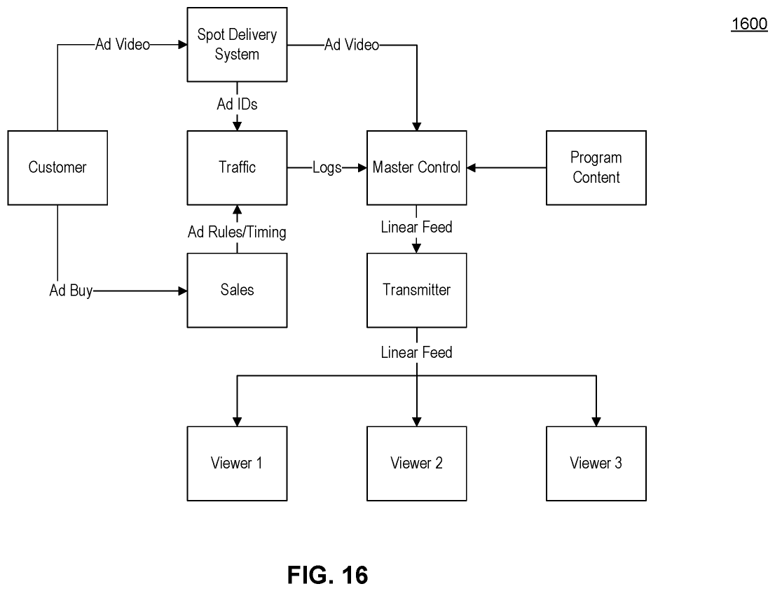

This section provides an overview of DAI, as well as why it is relevant to a broadcaster. In a linear ad sales model, as shown in FIG. 16 that illustrates ad assembly process 1600 for broadcast television, ads are sold 1601 ahead of time in varying categories, which establishes a set of rules on what ads need to be aired at what time, in what order, and next to what content or ads. These rules are then used by traffic 1603 to assemble the logs for each day, normally set out the day before. This results in a fairly static set of spots, though programming variances on live shows can sometimes cause more or fewer spots to be aired than planned. These variances are in turn often handled by a series of rules, with replacement spots or spot cutting priority being laid out in advance, though some broadcasters, particularly cable sports broadcasters, simply provide the dollar value of each spot in the logs to allow the operator to make rapid judgments in the moment. Regardless of this, each spot is sold on and shown to all viewers, with some exceptions as noted below.

By contrast, dynamic ads on streaming video services are generally sold in the moment, with an ‘instant auction’ being held to determine which spot should air. This is often handled by an external marketplace, such as, but not limited to, Google Ads, Magnite®, or The Trade Desk® to name a few. This is an almost fully automated system, with advertisers selecting budgets and audiences, then allowing the ad platform to handle the rest.

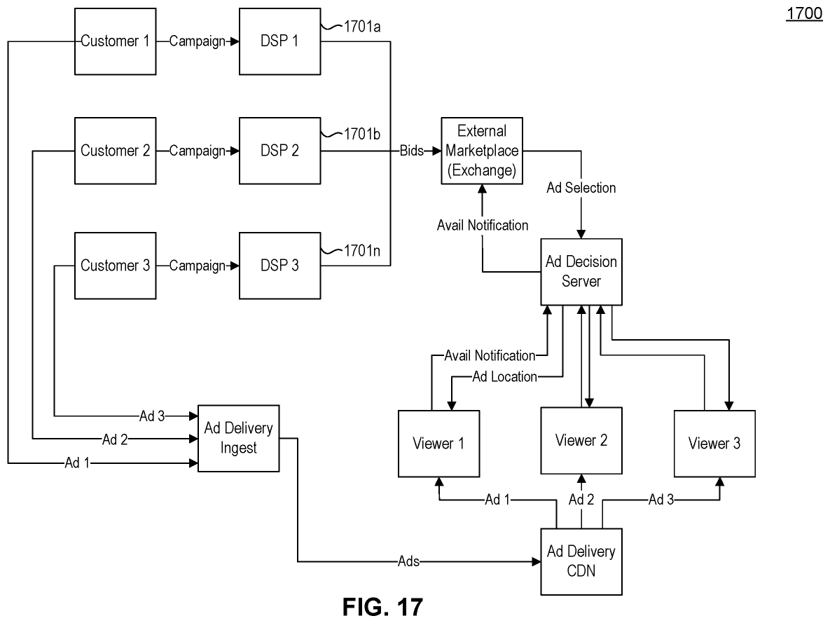

In this method, the stream contains an indicator of when an ad is available. These can take many forms, and some will be discussed in the next section. Regardless of method, it allows the client, generally controlled by the streamer, to determine when an avail begins and ends. When this information is received, the application, be it a website or native app, reaches out to the ad server to request an ad, generally giving information on the viewer, the avail location, and the duration. The server in turn offers the block up on an ad exchange. The Demand Side Platforms (DSP) (e.g., DSP 1701 of FIG. 17) contain the rules for airing the ad, the advertiser's budget for the campaign, and the ad content and metadata. The DSP uses this information to place bids for the block.

Once a winner is determined, the exchange then hands the ad back to the ad server, which in turn tells the client which ad to play. This whole process happens in a matter of milliseconds, ensuring a decision is made rapidly with no interruption to the viewer. FIG. 17 illustrates the ad assembly process 1700 for programmatic systems. FIG. 17 illustrates an example advertisement assembly process for programmatic systems, according to aspects of the disclosure.

While this is a drastically different approach from traditional broadcast sales, many broadcasters are already familiar with these methods. Digital, referring to website, social media presence, and other internet-based content from stations, has been rapidly growing across the industry, and is likely to continue doing so. Rather than linear feeds delivered in a unidirectional format, these are fully integrated content delivery systems with bidirectional feedback mechanisms. This has led to most broadcasters implementing some form of ad insertion system, particularly for first party owned content not normally covered by broadcast ad sales deals.

One other crossover point that can be noted is cable headends. While not fully targeted on an individual basis, these have long been used to do insertion on a geographic basis, at varying resolutions. This allows a few workflows:
Local Weather: National channels like The Weather Channel will often insert local weather information in their graphics via a keyer at the cable headend, allowing the viewer to see information relevant to their specific area.
Local News: While this practice has declined, national cable news networks splice in local news hits in partnership with stations in the area, similar to cut-ins on broadcast network news.
Cable Ad Separation: Some MVPDs prefer to air different ads for their customers compared to non-customer viewers. This allows them to offer deals to new customers, while advertising, for example, service upgrades to their current customers. This can happen at the station level, where the station handles the ad insertion and passes a separate feed to the MVPD, or in the MVPD infrastructure, where the station simply provides markers to allow the ad replacement.

Despite the broader brush, many of the concepts used for the MVPD insertion mechanism can be reused in a broadcast insertion method, as will be discussed in the next section. Indeed, vMVPDs such as YouTube TV® have begun rolling out ad insertion on linear feeds to enable these streaming ad advantages on a more traditional content model.

### DAI Options in ATSC 3.0

The ATSC 3.0 standard provides a few options for handling ad insertion. There are distinct pros and cons to each, and so it is important to match the correct solution to a given use case. This section will provide an overview of some of the potential systems that can be used. These cases will focus solely on ROUTE/DASH streams.

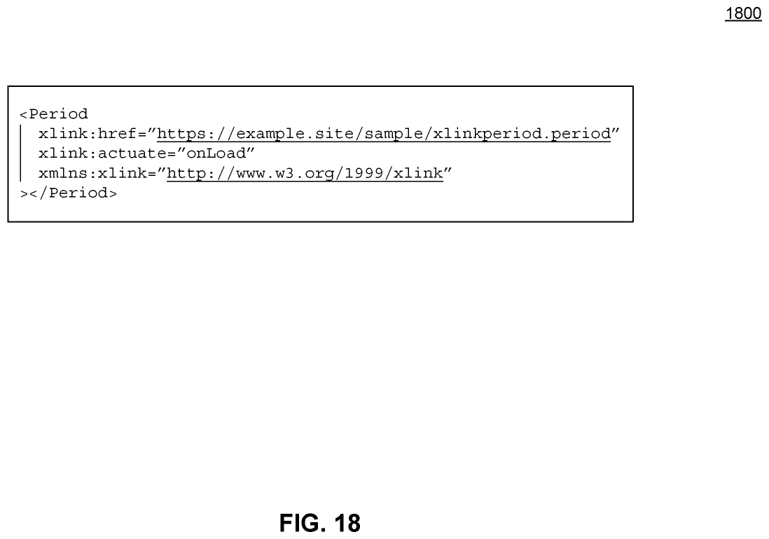

Regarding XML Linking Language (XLink), historically, XLinks have seen the most discussion when it comes to ATSC 3.0 ad insertion solutions. In this mechanism, the broadcaster generates a DASH stream with an xlink: href attribute, generally assigned to a period. This can be done at the beginning of an ad avail, with the encoder splicing the last segment before the avail to ensure a smooth transition. This creates the layout depicted in the sample MPD in FIG. 18, which illustrates an example of a period using an XLink. FIG. 18 illustrates an example DASH media presentation description (MPD) 1800, according to aspects of the disclosure.

According to some aspects, there are two options when the end device receives this MPD. In the event the xlink: href is pointing to some https location, the receiver can simply reach out as normal under the DASH spec and retrieve the correct content to insert into the MPD at that point. If it has any other URI scheme, it is instead passed to a BA (Broadcaster Application) that has subscribed to the XLink notifications. The BA then determines what content, either specific text or a full MPD, will be inserted at that location, and passes that information back to the receiver. This allows both online and offline ad insertion.

Regardless of which mechanism is utilized, the result is that the receiver is given a response with a new set of text. This will contain the playback information for the specific ad chosen for the client to air, essentially splicing in the period for the ad to the main MPD. The receiver then proceeds to continue through the timeline as normal, returning to the original broadcast content when it reaches the end of the ad period and hits the next linear broadcast period.

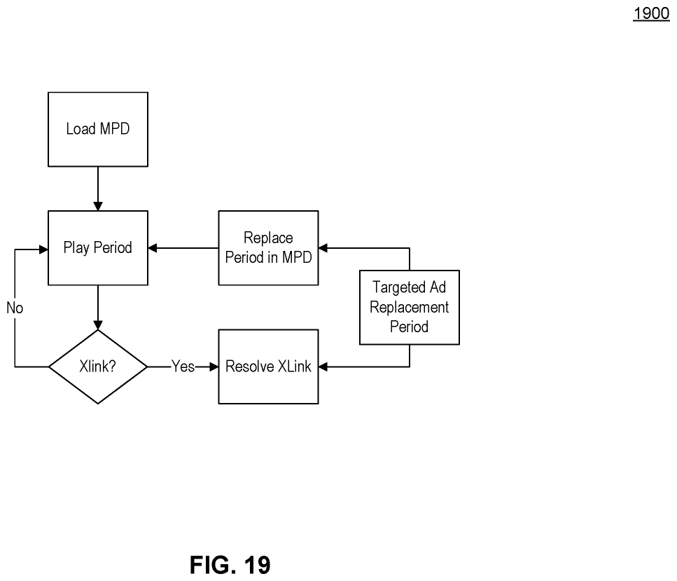

One major point in favor of XLinks is the ability for the receiver to resolve them locally, without BA involvement, by using https-based XLinks. This simplifies the process from the broadcaster perspective and means that if a receiver does not support the interactive environment, ad insertion still works. However, XLinks are not as flexible as Events (see DASH Events), require more complex receiver action, and most importantly, are in the process of being removed. FIG. 19 illustrates the XLink workflow 1900. FIG. 19 illustrates an example workflow for advertisement insertion using XML linking (XLink), according to aspects of the disclosure.

Regarding Out of Band Broadcaster Application Insertion, in this method, the broadcaster plays an ad via the BA at a specific time via the Application Media Player (AMP). This is the least elegant of the options described here, as the timing is virtually impossible to align due to the varying nature of reception. Receiver side delays, such as different player implementations and segment reception times, coupled with delays in the airchain, mean receivers will generally be off by at least several seconds from each other.

However, the method is worth noting as it eliminates any dependency on interaction with the receiver aside from implementing the interactive environment.

Regarding DASH Events, the DASH spec defines an EventStream element, which essentially form the DASH version of the SCTE markers common to the SDI and Transport Stream worlds. Events signal the time and duration of various data to the receiver. The use cases for events are quite broad; for ad insertion, they contain the full set of information from a SCTE marker, as well as the relative timing within the MPD timeline.

This workflow will be discussed more fully in the next section, but one item is the use of the Application Media Player (AMP) vs the Receiver Media Player (RMP). Because the AMP is controlled by the BA, it is very difficult to synchronize the insertion with the actual timeline on the receiver, despite the event notification containing the current and event times. This is due to variances in processing time causing potential offsets thus reducing the chance for a frame accurate insertion.

The RMP method, on the other hand, uses time marks relative to the RMP timeline. Assuming the receiver has correctly implemented the relevant APIs, it can seamlessly jump to the ad and back without misplacing the ad in either direction. This also allows the ad to take full advantage of the RMP's playback hardware, as not all receivers provide the same decode options to the AMP as they do to the RMP. For this reason, the preference is towards the RMP for ad insertion.

Overall, the Event workflow allows for the best accuracy in insertion with the least complexity on the receiver side. It also maintains the flexibility of SCTE markers, which is advantageous for non-insertion use cases. The spec is fully fleshed out, and well implemented by many receivers, as will be discussed below. The primary downside is that it requires the BA to handle the insertion logic, which means the receiver can implement the interactive environment and the relevant APIs.

### Connected Eventstream Workflow

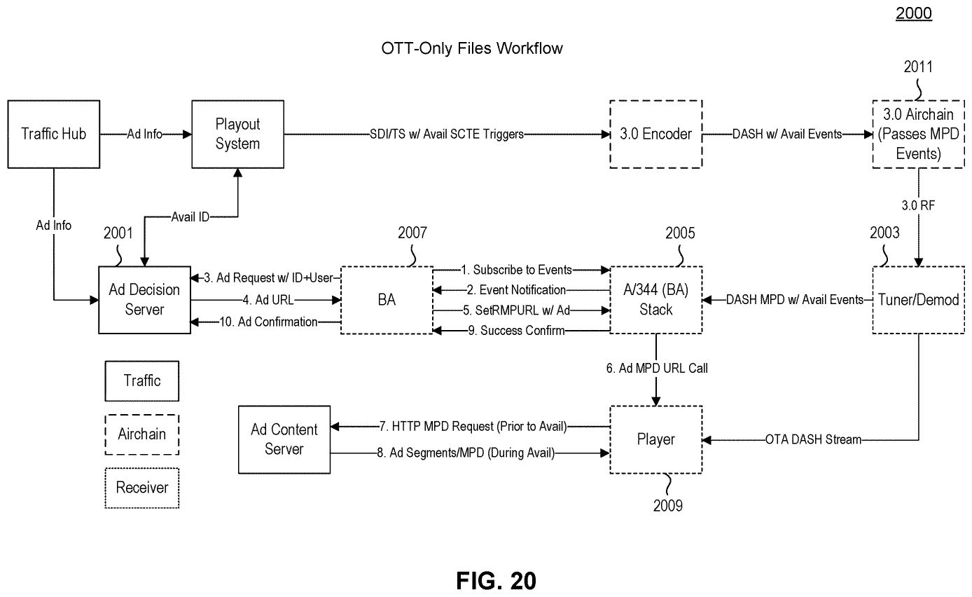

The best path forward, therefore, is to handle ad insertion with a combination of EventStreams and the RMP workflow. The following outlines this implementation in a connected device environment. This will form the basis for the implementation of the more complex broadcast implementation covered below. FIG. 20 illustrates the connected ad insertion workflow 2000.

Regarding transmission requirements, the first step in any insertion process is to figure out when the ads can be inserted (e.g., by Ad Decision Server 2001). This is best accomplished at the playout/automation stage, as the master control automation can generate the markers at the precise time the spot begins or ends. This allows the broadcaster to tag each break with the time of the break, the duration of the break, and an ID to allow the ad server to associate the break with a request on the receiver side. The automation system then adds this information, along with other optional functionality, to a SCTE 35 or 104 marker, depending on whether the video is being carried via a Transport Stream (TS) or Serial Digital Interface (SDI) transport.

In some aspects, a Tuner/Demod 2003, A/344 (BA) Stack 2005, a BA 2007, and a player 2009 are included in a receiver or associated with the receiver. The Tuner/Demod 2003 receives the 3.0 Airchain signal 2011 and demodulates it. The Tuner/Demod 2003 then transmits DASH MPD with available events to the A/344(BA) Stack 2005. The A/344(BA) Stack 2005 performs a series of message exchanges with the BA 2007 as shown in FIG. 20. In addition, the A/344(BA) Stack 2005 also transmits Ad MPD URL call to a player 2009. In some aspects, the A/344 (BA) Stack 2005, the BA 2007, and the player 2009 may be located in a user device, such as a cell phone, a tablet, a television, or the like. The Tuner/Demod 2003 may be located in a separate receiving device, such as a set-top box, a satellite receiver or others.

In ATSC 1.0, the SCTE marker would be carried unmodified into the TS stream used for the actual broadcast. However, ATSC 3.0 utilizes more advanced transports in the form of ROUTE/DASH and MMTP, so the markers can be translated into an appropriate format.

As mentioned earlier, the DASH spec contains an element called ‘EventStream.’ this comes in two forms: inband, and MPD-based events. Inband events can be found in the emsg box, with an InbandEventStream element in the MPD to indicate which representation contains the emsg box, while MPD-based events are located fully within the EventStream element in a Period of an MPD. Inband events are best used for unexpected events that require immediate action, such as rolling a news cut-in during a live network program and bringing the BA up for the duration of that cut-in.

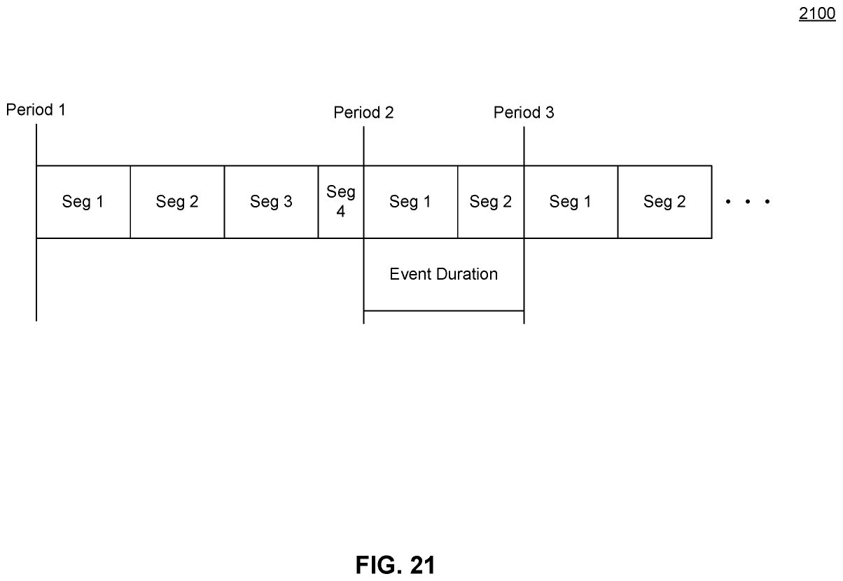

For ad insertion, the receiver needs enough time to buffer the ad media before the break to ensure a smooth and frame accurate transition in and out of the inserted ad. MPD-based events are therefore easier to execute in this situation. To achieve this, the encoder doing the DASH packaging can read the SCTE markers on the input, noting the time on each one to ensure the time is maintained relative to the new DASH timeline. It can then splice the segment at the indicated time and generate a new period with a new timeline beginning with the second half of the spliced segment. This ensures a complete Group of Pictures (GOP) at the start of each Period, which is critical to allowing the player to switch between two distinct streams with no interruptions. Without this, it would need to wait for the next I-frame when resuming the live broadcast after an ad, which would lead to some amount of black video. FIG. 21 illustrates an example of segment splicing for event periods 2100. FIG. 21 illustrates an example segment splicing for event periods, according to aspects of the disclosure.

Once the splicing is completed, the packager can then generate the corresponding MPD for these segments. Each new avail, indicated in the source feed by the SCTE splice_insert markers, generates a new period in the MPD. So, in a workflow where the feed is going program-break-program, with the break listed as one large avail, the MPD would initially have a single period. Around three to ten seconds before the break, the input would receive the first of the SCTE markers. This could either be an open-ended avail with no duration signaled, indicating no specific time to return, as is sometimes seen in live events, or a fixed duration avail, which is common in a broadcast station running fixed ad breaks. In either case, the packager would generate an early available period in the MPD. This is a period that has no segments but indicates that there will be a period in the future. In this case, this period also contains the EventStream element, allowing the receiver to begin processing the event before it comes up in the timeline.

This element has several attributes:
presentationTimeOffset: Present in the individual events (non-offset) and the EventStream (offset), this indicates the time within the period that the event occurs. For example, if the event has a PTO of 1100, and the EventStream's PT is 1000, then the event would occur 100 timescale units into the period.
schemeIdUri: This identifies the scheme used for the events. The majority of events will be urn:scte:scte35:2014:xml+bin or urn:scte:scte35:2014:xml+bin, but there is a provision in the ATSC spec for the use of custom URIs.
value: This optional attribute allows the receiver to distinguish between events when the BA subscribes to specific values, as described in the BA workflow later in this section.

The EventStream element in turn has several child elements, named Event, which identify the individual events within the element. These events again have a series of attributes to enable the timing:
presentationTime: This is used as described in the PTO section of EventStream.
duration: This is optional and not present in open-ended avails. It indicates the expected time of the avail to allow the ad decision server to put together a playlist of appropriate length. This can be modified in later MPD updates if, for example, the program needs to come back early.
id: This indicates an identifier within the URI and value. The id is most useful as a transfer from the SCTE marker. In this way, the ad logic on the receiver side can determine which ad break is upcoming, as it has a record of the IDs and their corresponding breaks available.
Data: Within the Event element, the packager can insert arbitrary data in XML form. In the urn:scte:scte35:2014:xml+bin scheme, this is utilized to place the full body of the SCTE marker in base 64 encoding within the event, giving 1:1 parity on SCTE features to DASH events.

At this point, the DASH stream now has a properly spliced set of representations, along with events to indicate the timing and reasoning for each splice. The transmit side can now feed the DASH stream into the ROUTE encapsulator, add the appropriate signaling, and bundle it all into an ATSC 3.0 transmission. Everything after the DASH packager is simply passing along the stream unmodified.

Regarding receiver requirements, the receiver can now process the essence and signaling, then communicate to and from the BA using the standard interactive content APIs. According to some aspects, the core function revolves around two sets of APIs: those pertaining to the events, and those pertaining to changing the RMP source.

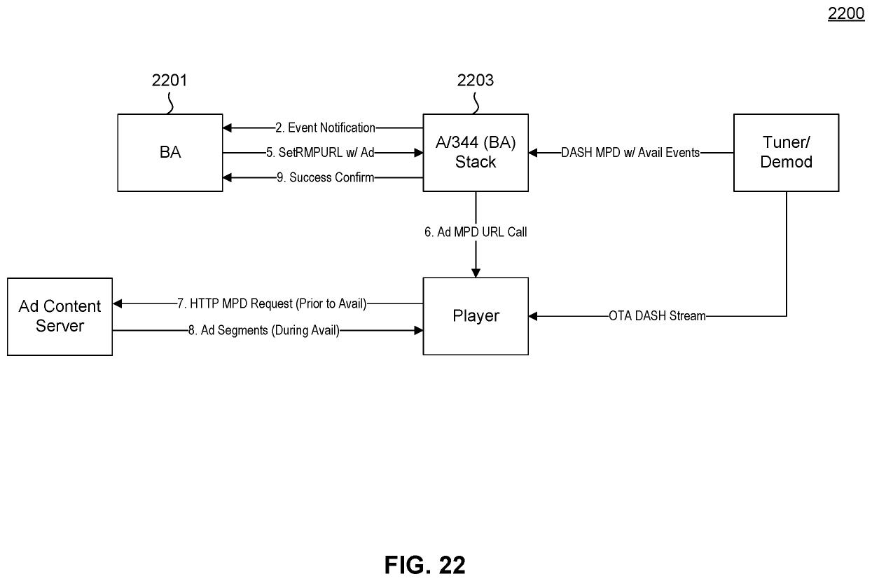

When receiving a DASH service, the receiver is expected to monitor the MPDs for new events whenever the MPD version changes. The new events can be supplied not only by the DASH items described above, but also by methods like video watermarking or out of band delivery. MPD-based DASH events are the ones relevant for this DAI workflow. FIG. 22 shows the receiver section of the workflow 2200. FIG. 22 illustrates an example receiver section workflow, according to aspects of the disclosure.

When the receiver spots an event, it notes the listed attributes and calculates the current time and the time the event will occur relative to the current media presentation timeline. It then sends a notification to any BA 2201 subscribed to events with a matching schemeIdUri and optionally a matching value. The notification contains the currentTime and the eventTime. The BA 2201 can now calculate the time until the event and tell the receiver to execute an action relative to the eventTime with a high degree of precision. It also provides the id and duration attributes, and any data contained within the element.

The BA 2201 will then process this notification, as discussed below. At some point between the notification and event, if the BA 2201 chooses to insert an ad, it will make a Set RMP URL call to the receiver (e.g., A/344 (BA) Stack 2203). There are several operations allowed in this call, but for the purposes of ad insertion, startRmp and resumeService are necessary. In the initial call, the BA 2201 will utilize startRmp, with rmpSyncTime set to the eventTime from the prior notification. This tells the receiver to, at the time the event is set for, switch the Receiver Media Player (RMP) to an alternative MPD with a given URI. This is the critical component for frame accuracy, as the event is placed at the precise time on the timeline where the splice occurs. This provides a dramatic improvement over systems that utilize wall-clock time, as the time remains consistently expressed in terms of the timeline on the player, regardless of how far off the internal time may be. It also means that precise timing on the BA call is unnecessary, as the RMP change is set to a fixed time on the timeline, rather than one relative to the current time.

Ideally, the receiver begins buffering the MPD ahead of the eventTime to ensure a smooth transition with no black sections. If the MPD has not been buffered, it can cause brief interruptions while the receiver acquires the MPD and segments. This can lead to a viewer missing the beginning of the next program block, an unacceptable result for all parties. In the event the receiver does not buffer, however, there is an alternative approach that is discussed below.

In a normal situation, the receiver would play through the presentation referred to by the new MPD, and upon reaching the end, return to the primary MPD by default. However, breaks may end early or otherwise be interrupted. In this scenario, the BA may choose to cut out of the ad early rather than cover programming with a spot. To do so, the BA makes a Set RMP URL call, but instead of specifying a URI and using the startRmp operation, it uses the resumeService operation with no rmpurl. The time is either left empty to immediately resume, or the time is specified to resume based on the time in the event indicating the break is ending early.

The receiver can also supply information on the device and user and confirm an ad has successfully run. The former is accomplished using the Query Device Info API, which provides the deviceId and advertisingId of the receiver to the BA. This allows the BA to associate the receiver with a given profile of a viewer for ad decisioning.

The confirmation that an ad has run is handled using the RMP Media Time Change Notification. When the BA is subscribed, it receives a notification any time the player time changes. This occurs when the Set RMP URL API is used, as the timeline in the ad will be different to that of the main service. The BA knows the notification is caused by the player beginning playback of the ad, and later resuming the main service on completion, because of the ‘source’ section of the API

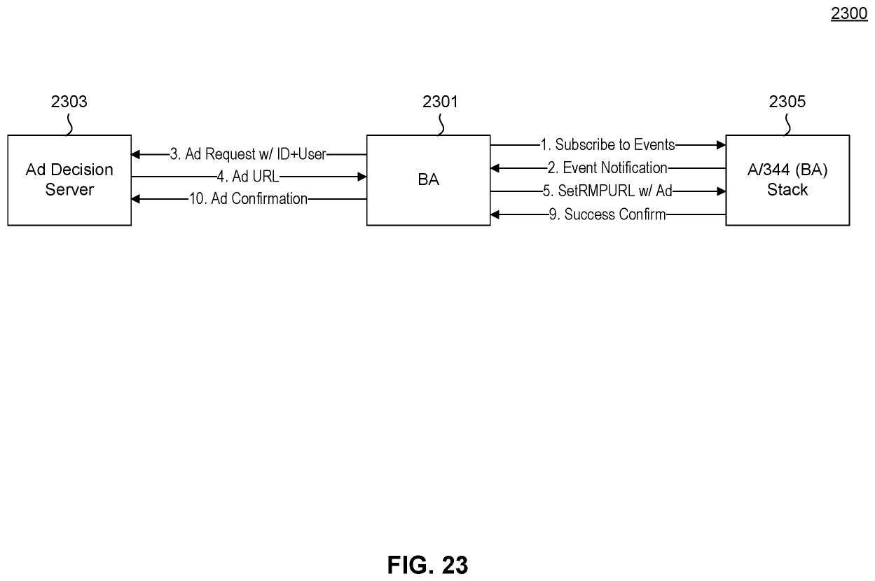

Regarding Broadcaster Application Requirements, in the model described in this section, where an internet connection is available, the BA has a lighter workload, as many of the responsibilities discussed below are offloaded to remote servers. FIG. 23 shows the BA component of the system 2300. FIG. 23 illustrates an example broadcast application (BA) component of the system, according to aspects of the disclosure.

When the BA 2301 launches via the HELD upon the user selecting the relevant service, the first thing it can do is subscribe to the relevant notifications: events and RMP media time changes, both described above. It should also query the device info to retrieve the two relevant IDs to reduce the delay when it comes time to request an ad from the decision server. With these tasks accomplished, it can then wait for an event to come through.

When an event indicating an avail does come through, the BA will immediately hand off the advertisingId, avail ID, and duration to the ad decision server 2303 to request an ad. The server 2303 uses the avail ID to determine what rules will be applied based on the surrounding content. This avoids situations like duplicate spots airing adjacent to each other. The advertisingId, meanwhile, is associated with prior data gathered on the user to enhance the ad selection process. Based on these three items, the server 2303 puts together the ad or ads to be aired during the avail, and hands the URL(s) back to the BA 2301, potentially including a callback URL to indicate whether the ad successfully aired at a receiver (e.g., A/344 (BA) Stack 2305). The BA 2301 in turn makes the calls noted above to begin playback of these ads.

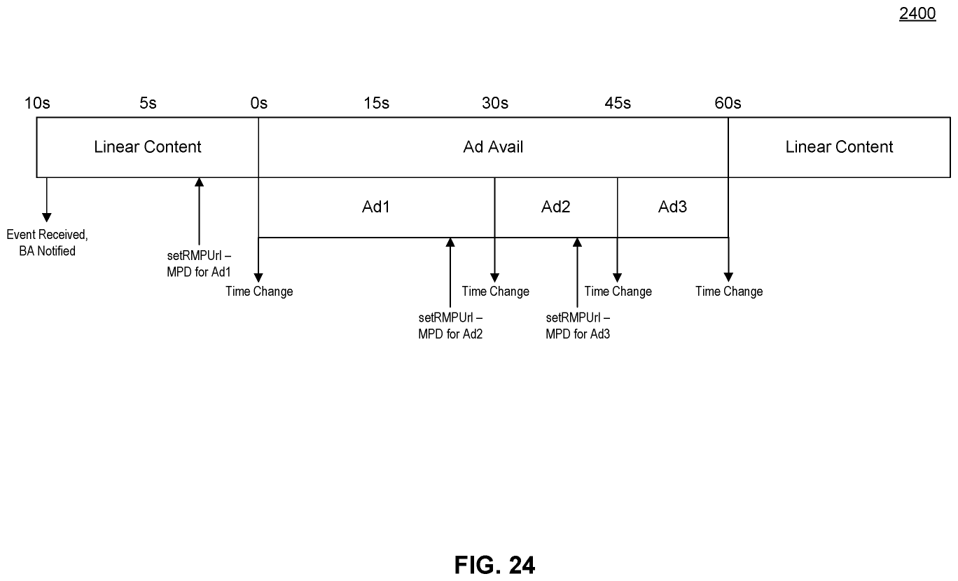

The receiver section covered the case of a single ad, but as noted above, there can be multiple ads in a single block, particularly if breaks are being signaled as one large break. Luckily, this is handled through a slightly different usage of the SetRMPURL API. Rather than setting the rmpSyncTime to nothing or a specific time, it can instead be set to −1.0, which tells the receiver to execute the action upon completion of the current media presentation. One call can be queued at a time, however, so it is important to wait until the preceding presentation has begun before calling the next startRmp. This is achieved using the time change notification mentioned earlier, as it triggers just as easily going between ad presentations, as it does going from program to ad and back. The sequence of events 2400 can be seen in FIG. 24. FIG. 24 illustrates an example sequence of operations for inserting multiple advertisements, according to aspects of the disclosure.

Once the receiver has handed off the URL(s) to the receivers, it listens for the time change notifications and notifies the ad decision server's API whether the ad has successfully run. And with that, there is a fully functional connected device insertion.

### Broadcast-Only Reasons and Restrictions

While the combination of functions is relatively new, the system described above can be put together with standard-based ‘building blocks,’ leaning primarily on the existing ad infrastructure used in streaming. This works well in markets like the US or Korea, where broadband access and connected devices are common. The aspect of this disclosure can operate in regions with lack of reliable internet access, with many users reliant on mobile data to connect. The availability of mobile data in particular varies wildly in standards, speed, and access.

As part Direct-to-Mobile (D2M), one of the core features can include linear services on mobile devices with ad insertion and minimal internet usage. The goal is to increase efficiency by offloading as much common data as possible to broadcast delivery, while maintaining a minimal internet backchannel that does not require constant availability.

This results in the following restrictions compared to the connected device scenario:
Ads cannot be retrieved from an external server, and so can be delivered via broadcast
Ad decision logic can be local to the receiver
No immediate feedback mechanism for ad reporting is available due to inconsistent internet availability.

### Broadcast-Only Solutions

This section will cover each of the restrictions individually, and explore the solutions devised for each of them.

Regarding Locally Sourced Ad Media, the ad media is the most internet intensive component of the broadband solution, as the receiver is effectively streaming the ad for the duration of the spot. This is due to the individualized nature of targeted advertising, which in a US-style broadband environment, makes it preferable to save the broadcast bits for other items. However, when broadband is less reliably present, that equation shifts back towards broadcast.

Other solutions have discussed the usage of parallel advertising, in which multiple ads are transmitted simultaneously during a given ad break, with the receiver switching between multiple MPDs to choose the preferred ad for the viewer. While this makes synchronization easier, it negatively affects broadcast efficiency for two reasons.

First, if an ad is going to be reused, it is sent multiple times, once in each break. In the first airing, it requires the same number of bits as a Non-Real Time (NRT) solution. However, each subsequent break will double, then triple etc. the number of bits required by the parallel solution. The receiver could cache the ads after they're received, but that loses the timing advantage over the NRT solution.

Second, broadcasts have a fixed number of bits available in a time unit. Therefore, when real time delivery is required, the transmission of the ad media can't simply be averaged over a long period. Instead, it can utilize the live bitrate of the media. Broadcasters max out their PLP payloads, so there isn't normally bitrate available for the additional video bitrate necessitated by the ad. Workarounds like running the ads at a lower bitrate or using a dynamic spectrum allocation tool run into issues if multiple services go to a break simultaneously.

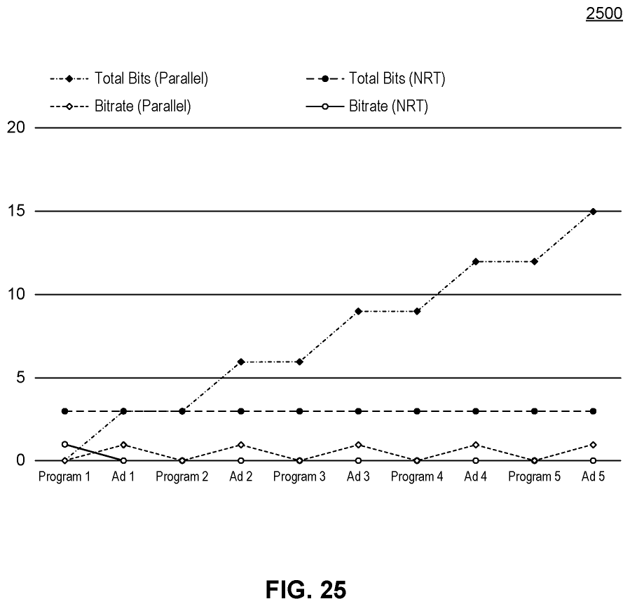

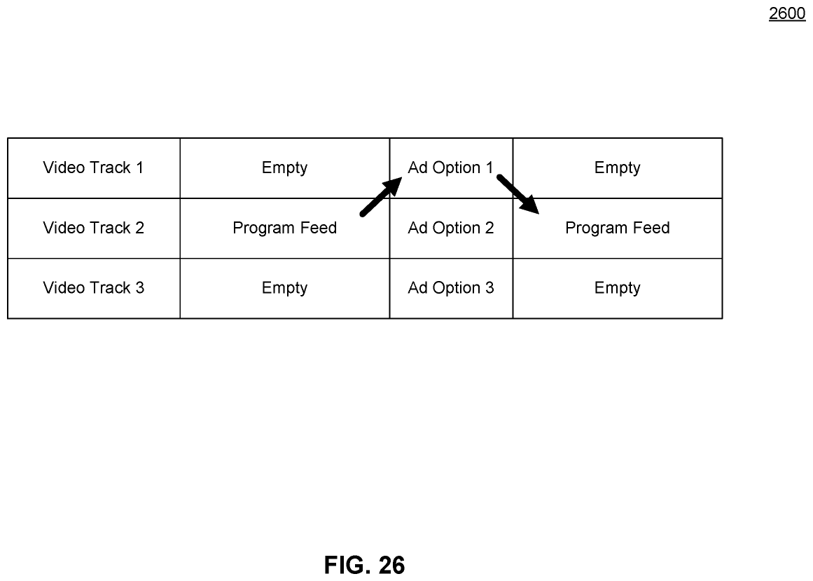

Instead, the other option is to deliver the ads as NRT files. This means sending the media in a bundle in advance, ideally during non-peak hours when more spectrum is available. Because this media is not critical to the user experience, as the service can always fall back to the linear feed, it does not need to be sent 24/7, which reaps significant savings in bit consumption over the parallel approach. FIG. 25 illustrates a comparison 2500 of resource usage between the two delivery solutions. FIG. 26 illustrates the sequence 2600 for the parallel ad workflow.

One downside, however, is storage usage. Caching every possible ad can get quite unwieldy, particularly in a model where the phone is designed to act as a nano-CDN for other applications, which means local storage can become a premium. Luckily, there are a few workarounds to avoid this:

First, proper signaling. The ATSC 3.0 spec includes an optional ‘validUntil’ attribute for individual files within a package. This enables the receiver to discard the files when no longer needed, reducing the cache load. For example, if the broadcaster knows an ad campaign will run through a given date, they can signal the validUntil for that date.

Second, the use of filter codes. These are a set of identifiers unique within a single appContextId which can be used to filter files by relevancy. Once the application has built a user profile, it requests the receiver to retrieve files matching the filter codes, which correspond to ads relevant to the viewer. For example, if the viewer consistently watches cooking shows, cricket matches, and soap operas, the BA selects the filter codes corresponding to kitchen tools, sports memorabilia, and soap opera promos. Filter codes are 32-bit unsigned integers, so it is easy to get as granular as desired in the selection of ads. These workarounds ensure a slim cache while keeping relevant ads available, all with a minimum of spectrum usage.

Scheduling is also key, as a tuner shouldn't constantly remain tuned to receive ad media, particularly on battery-dependent mobile devices where every watt counts. Fortunately, the Distribution Window Description (DWD) table within the Service Layer Signaling (SLS) contains the start date, end date and time for each file transmission, as well as a label to distinguish duplicates, the AppContextId and filter codes for each file. The DWD is analogous to the Electronic Service Guide (ESG) but for file delivery. Using this table, the receiver can tune to the signal at the scheduled time and cease tuning once the file is received. The filter codes ensures relevant files are received.

Regarding Offline Ad Decision Logic, the ad decision logic is the next piece of the puzzle. The logic can be run wholly within a lightweight BA using the typical ad insertion workflow described above. One goal is to prove the concept, so the actual user data and ad categories were limited, as were the rules for airing the spots. However, there is no reason this same methodology would not apply to a full production system.

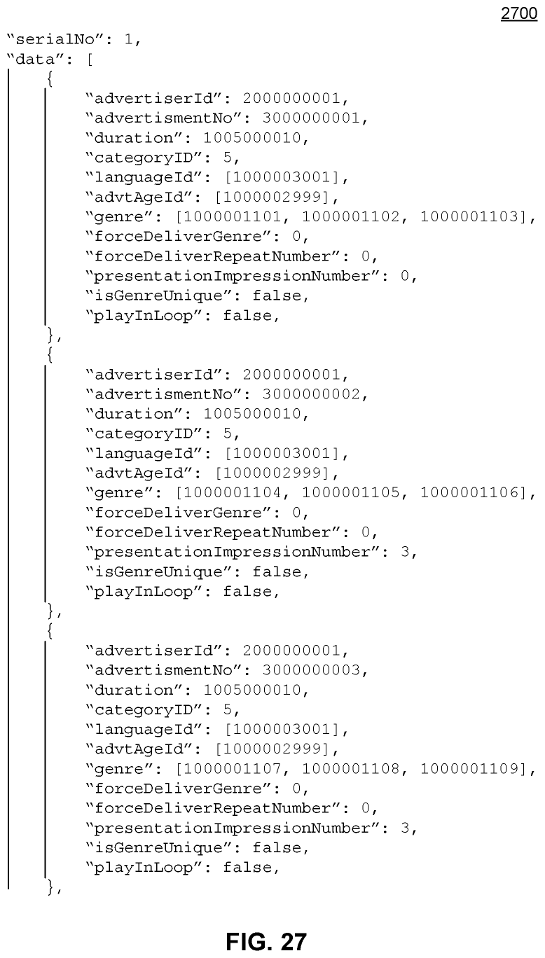

It is initially discussed using filter codes to communicate all of a file's metadata, but this became unwieldy as more detail to each piece of ad media began to be added. Instead, a separate ad manifest containing the metadata for each piece of content available on the broadcast is created. This allowed the logic engine to determine which files should be downloaded off the air and to build ad playlists using the rules described in the manifest. FIG. 27 illustrates an excerpt 2700 from a sample metadata file from the pilot.

Some attributes of excerpt 2700 are as follows:
advertiserId: Identifies the advertiser, e.g. Bob's Discount Cars, or Coca-Pepsi.
advertisementNo: A unique identifier for an individual spot.
duration: Length in seconds of spot.
languageID: Identifies the language used in the ad to ensure the viewer can understand it.
genre: One or more genres the advertisement is relevant too, e.g. news, movies, music, sports, travel, shopping, or finance.
presentationImpressionNumber: Indicates the maximum number of times an ad can be played on a given device, with 0 indicating no limit.
forceDeliver: Overrides all other rules to air a spot for a given genre, with the repeat number indicating how many times.

The file is transmitted as part of the BA and updated with new ads via the validFrom field to indicate when a new version is available. Once the BA has the manifest file, it calls the relevant APIs to set the filter codes, then checks for upcoming media via the DWD.

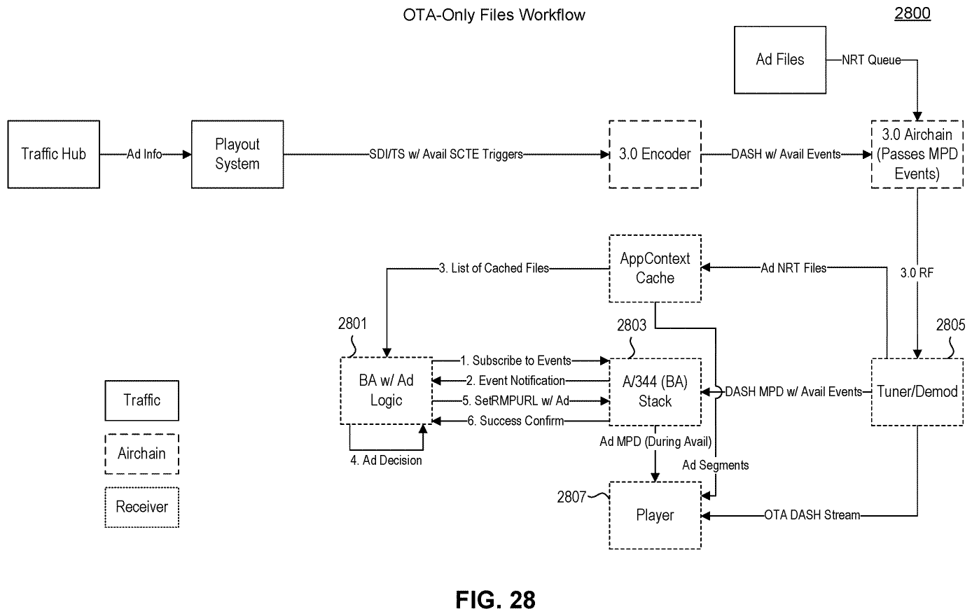

The workflow for the event processing is then virtually identical to the connected method. FIG. 28 illustrates the workflow 2800 for broadcast-only ad insertion. Some differences compared to workflow 2000 of FIG. 20 are as follows:
The rmpUrl points to an MPD inside the Application Context Cache, rather than an internet one, corresponding to the chosen ad.
The BA 2801 can check what ads are available in the cache before choosing one, as receivers 2803 can discard files from the cache at will.
The decision logic is done according to the manifest rules, rather than calling the decision server API.
Precaching, discussed below, is unnecessary, as the files are already in the cache.

In some aspects, a BA with Ad logic 2801, a A/344 (BA) stack 2803, a Tuner/Demod 2805, and a player 2807 may be included in a receiver or associated with the receiver. The Tuner/Demod 2805 receives 3.0 RF signals and demodulates them. The Tuner/Demod 2805 then transmits DASH MPD with available events to the A/344(BA) Stack 2803. The A/344(BA) Stack 2803 performs a series of message exchanges with the BA with Ad logic 2801 as shown in FIG. 28. In addition, the A/344(BA) Stack 2803 also transmits Ad MPD to a player 2807. In some aspects, the A/344 (BA) Stack 2803, the BA with Ad logic 2801, and the player 2807 may be located in a user device, such as a cell phone, a tablet, a television, or the like. The Tuner/Demod 2805 may be located in a separate receiving device, such as a set-top box, a satellite receiver or others.

Regarding inconsistent feedback mechanism, the whole purpose of dynamic ad insertion is to increase the value of each spot. However, much like a tree in the forest, if a targeted ad airs but no one knows about it, how does the broadcaster get paid? This is the problem with the inconsistent return channel and the lack of internet-delivered ad media. With a connected device, the BA 2801 can send a message to the ad server to indicate an ad was successfully run, and the advertiser knows a device accessed the ad from their server at a specific time. With a disconnected device, both of those options are gone. The solution was to accumulate a record of the ad airings and send them in bulk the next time the device connects to the internet. This, of course, has high potential for fraud, so this component needs the most additional work, as will be seen in the next section.

### Optimization and Other Discussions

Now that some core functions of this methodology are discussed according to some aspects, for both connected and low-connectivity markets, this disclosure moves on to optimize and advance the system with the following refinements.

Regarding Preloading Content, in the connected model, there is a danger the receiver may wait until the syncTime to begin buffering the segments. This would result in delays entering and exiting the avail, causing black at the start and overlap at the end. Ideally, receivers would simply begin buffering upon receiving the Set RMP call, but this cannot be guaranteed. Luckily, the cache request API can be used specifically for this situation. The API allows the BA to cache the necessary segments from a DASH MPD.

Under this model, the BA processes the event like normal, but instead of directly setting the URL in the Set RMP call, it calls the cache request API repeatedly until it confirms that all files are in cache. Once this is received, the BA would call Set RMP and point to the local MPD instead of the remote one. This will enable near perfect frame accuracy regardless of the receiver's buffer model, as it will instantly have the full MPD available.

Regarding Common Data Services, currently, files intended for a BA are transmitted alongside each service. This leads to inefficiencies in distribution, as multiple services will likely be consuming the same ad media. Unfortunately, no default tune service for files exists the way it does for service information via the ESG. The new Data Service category fulfills the role well for private file distribution, but it's specifically intended to be ignored by receivers that do not know the GSID. A “common service” intended for files consumed by multiple services would address this. The Common Data Service would eliminate duplicate files, with backwards compatibility maintained via signaling the file transmissions in each service for those receivers that don't update to the new category.

Regarding Ad Skipping, when providing a receiver with each ad's start and end times, it enables DVRs to easily skip past all the ads in a recorded broadcast. While this is a narrow case, particularly as most DVRs are very capable when it comes to automatic commercial detection, it is a topic worth exploring in future modifications. There may be some form of obfuscation that can be used to raise the bar above the lowest hanging fruit.

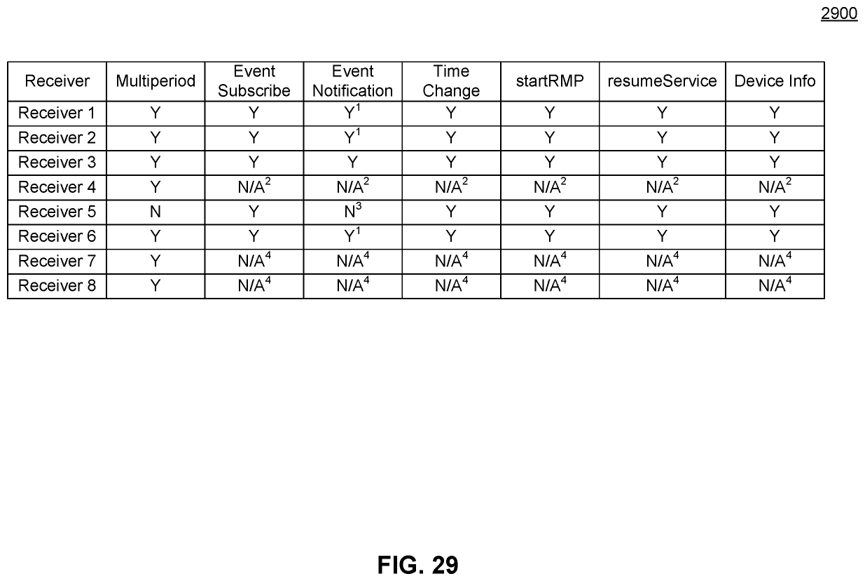

Regarding Receiver Support, while the APIs in question are part of the NextGenTV logo suite, that does not necessarily guarantee all receivers will behave the same way. Initial testing has been done to validate the presence of the APIs and the viability of the workflow, as can be seen in the table in FIG. 29, with the manufacturer names altered for confidentiality reasons. FIG. 29 illustrates an example test 2900 to validate the presence of APIs and workflow validation, according to aspects of the disclosure. The core event notification functionality is present, but with some bugs that require adaptations on the transmit side, according some aspects. The BA fails to run the Javascript, instead displaying the HTML, which causes the other tests to fail. This appears to be due to a BAAppear implementation. Event notifications are unable to be tested without multi-period support in implementation, making this an automatic fail. Receiver does not implement A/344.

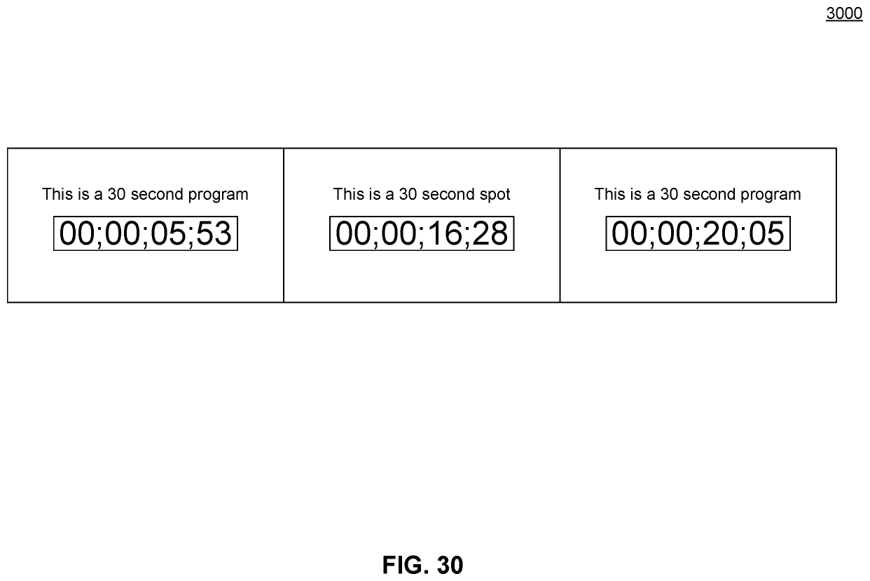

Additionally, the timing possibilities are validated with receiver stack, using a test system with a series of countdown timers, as shown in the sequence in FIG. 30. FIG. 30 illustrates an example timing possibilities validation 3000, according to aspects of the disclosure.

Failure simply means the insertion does not occur and the linear feed will play as normal. The exception is Receiver 5, which does not support multi-period video, and so will require a fix before deployment.

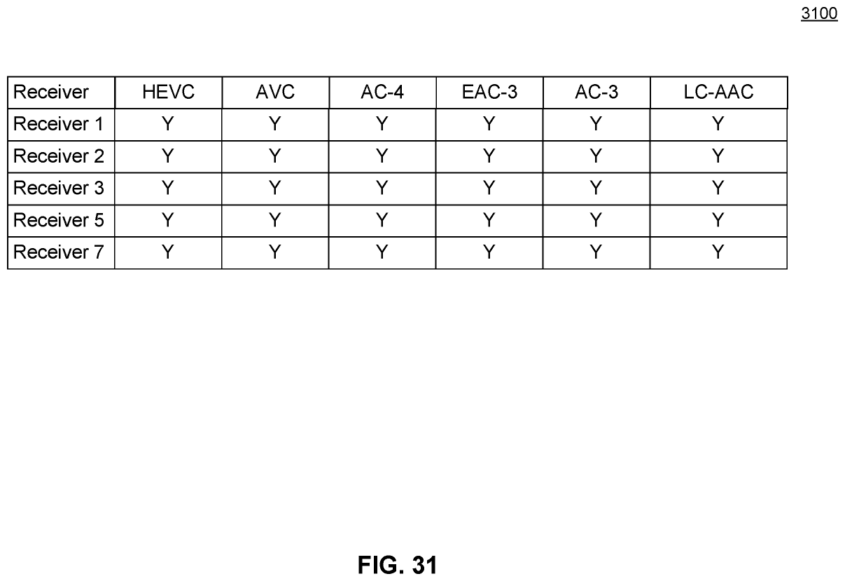

Codecs are another concern as not all RMPs support the same codecs, including many common ones used in streaming. Audio has been a particularly mixed bag historically. The ingest workflow for ads will be to ensure the viewer does not experience silent audio or video due to poor media choice. This, however, is a user-by-user issue, so codec requirements can be set in the BA on a per-model basis, allowing the BA to choose not to air an ad with an unsupported codec. Fortunately, this is a situation that has improved over the years, as the table in FIG. 31 showing the results 3100 of various codecs in the RMPs of common receivers.

In summary, this solution is a viable method for both connected and broadcast-only ad insertion. It avoids problems discovered in previous solutions, while adding additional functionality, including for non-content replacement-based use cases. It also makes use of long-established standards and APIs that are well-supported on all but a few receivers.

### VAST Conversion

A method of information exchange for ad servers is VAST, which contains the information about an ad, including how/when it should be used, as well as metadata about the media itself. Critically, the media can be delivered in one or more of several ways, namely DASH, HLS, or a single file piece of video in a container such as an mp4. This works well for normal advertising, as players are fairly versatile in what they can play. However, for content replacement in ATSC 3.0, the setRMPURL call requires that a DASH MPD is used. This means that if the VAST response lacks an MPD entry, the video may need to be converted to DASH, all in the course of milliseconds to ensure it is delivered to the BA in time to queue for content replacement.

A few scenarios are covered in the diagram above. The first step is to read the VAST and look for the media contents. If it contains an MPD, this is handed to the BA directly in the API response from the decision server. If it contains an HLS stream, the method then checks if it is using CMAF segments, which are compatible between DASH and HLS. If it is, the method generates a simple MPD and store the segments+MPD temporarily in a cache on the decision server, then hands that MPD URL to the BA. If it is not CMAF, or if it does not have HLS at all, the method next needs to examine the container of the media. If it's a single segment MP4 or TS, the method can use this in a one-segment DASH MPD. If it is multi-segment HLS, or some other container, the method can first remux it into a proper container, such as MP4. Once the correct container is obtained, the method then generates an MPD listing a single segment, which is handed to the BA.

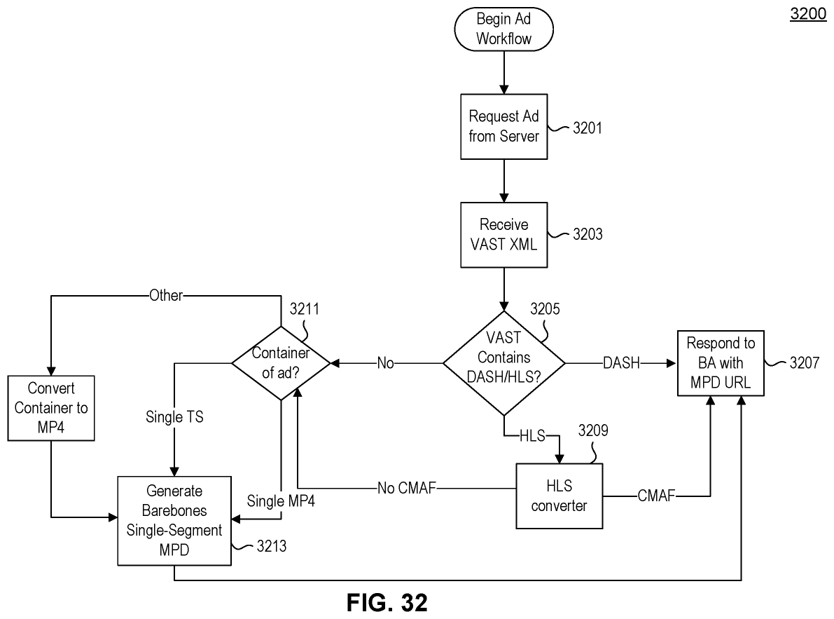

Because this does not involve any transcoding, just MPD or container alterations, it can be done rapidly, in the limited time available for an ad response, and returned in the response to the BA's API call. This allows for a large variety of media to be used in the content replacement process, rather than just those with DASH incarnations. FIG. 32 illustrates a flow chart of the VAST conversion, according to aspects of the disclosure. At 3201, a server receives a request for Ad from a receiver. At 3203, the receiver receives a VAST XML file from the server. At 3235, the receiver determines if the VAST XML file contains DASH or HLS. If the VAST XML file contains DASH, the control moves to 3207 and the receiver responds to the BA with MPD URL. If the VAST XML file contains HLS, the control moves to 3209 and the receiver checks whether the VAST XML file uses CMAF segments. If yes, the control moves to 3207 and the receiver transmits the CMAF segments to the BA because CMAF segments are compatible with the DASH and HLS. If no, the control moves to 3211. At 3211, the receiver examines a container of the Ad. The Receiver then processes the VAST XML files depending on whether the container of the Ad is a single TS, a single MP4, or others. In any case, at 3213, the receiver generates barebones single-segment MPD and the control moves to 3207 where the receiver transmits the barebones single-segment MPD to the BA. Referring back to 3205, if the VAST XML file does not contain DASH or HLS, the control moves to 3211 and the VAST XML file is processed based on the container of the Ad as discussed here above.

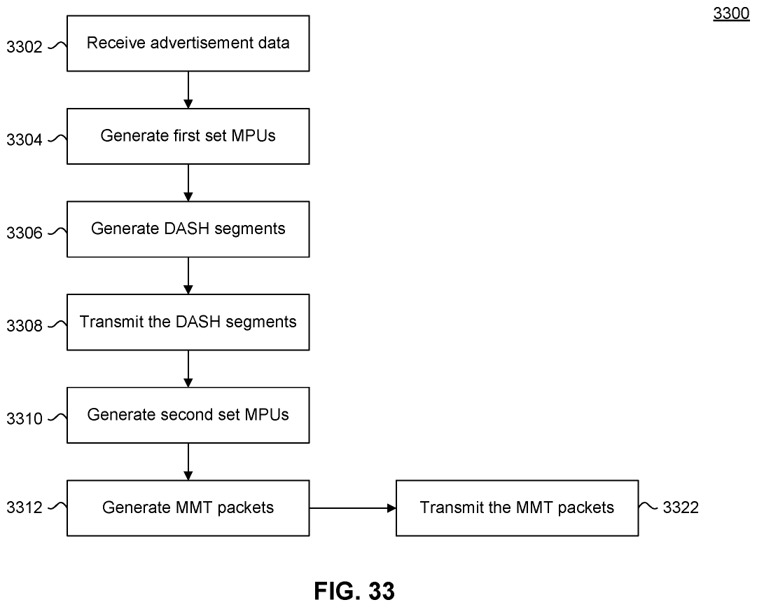

FIG. 33 illustrates an example method of advertisement insertion, according to aspects of the disclosure. The example method is not limited to the specific embodiments depicted in those figures and other systems may be used to perform the method, as will be understood by those skilled in the art. It is to be appreciated that not all operations may be needed, and the operations may not be performed in the same order as shown in FIG. 33.

At 3302, an advanced television systems committee (ATSC) apparatus, such as a BG, receives, from the data distribution platform, such as a DDaaS platform, advertisement data.

At 3304, the ATSC apparatus generates a first set of media processing units (MPUs) that includes the advertisement data.

At 3306, the ATSC apparatus generates DASH segments based on the MPUs. In some aspects, the DASH segments include the MPUs.

At 3308, the ATSC apparatus transmits the DASH segments using a real-time object delivery over unidirectional transport (ROUTE) protocol to a receiving device. In some aspects, the receiving device may be a user device, a user equipment, a cell phone, a mobile device, a set-up box and the like.

At 3310, the ATSC apparatus generates a second set of MPUs that includes live media stream corresponding to broadcast content. The broadcast content may be sports events, news broadcasts, weather broadcasts, and the like.

At 3312, the ATSC apparatus generates MPEG media transport (MMT) packets that include the second set of MPUs and one or more markers corresponding to the advertisement data.

At 3322, the ATSC apparatus transmits the MMT packets using a MPEG media transport protocol (MMTP) to the receiving device.

In some aspects, the ATSC apparatus transmits the DASH segments prior to transmitting the MMT packets. Thus, when receiving the MMT packets, the receiving device would already have content in the DASH segments stored in its local storage. In some aspects, the one or more markers indicate when to insert the advertisement data into the live media stream.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

### Abbreviations

Ad I—Advertisement Insertion
ATSC—Advanced Television System Committee
DASH—Dynamic Adaptive Streaming over HTTP
DDaaS—Data Distribution as a Service
DMA—Designated Market Areas
FEC—Forward Error Correction
MFU—Media Fragment Unit
MMT—MPEG Media Transport
MPU—Media Processing Unit
NRT—Non-Real Time
OTA—Over-the-air
OTT—Over-the-Top
QoS—Quality of Service
SCTE—Society of Cable and Telecommunication Engineers
SSAI—Service-Side Ad Insertion
VAST—video ad serving templates
XLink—XML Linking Language

What is claimed is:

1. An advanced television systems committee (ATSC) apparatus configured to implement dynamic advertisement insertion comprising:
a transceiver configured to enable communications with data distribution platform and a receiving device configured to receive broadcast content; and
a processor, communicatively coupled to the transceiver, and configured to:
receive, from the data distribution platform, advertisement data;
generate Dynamic Adaptive Streaming over HTTP (DASH) segments including advertisement data;
transmit the DASH segments using a real-time object delivery over unidirectional transport (ROUTE) protocol to the receiving device;
generate a set of media processing units (MPUs) that includes live media stream corresponding to the broadcast content;
generate MPEG media transport (MMT) packets that include the set of MPUs and one or more markers corresponding to the advertisement data; and
transmit the MMT packets using a MPEG media transport protocol (MMTP) to the receiving device,
wherein the processor is configured to transmit the DASH segments or to transmit the MMT packets, and
wherein the one or more markers indicate when to insert the advertisement data into the live media stream.

2. The ATSC apparatus of claim 1, wherein the processor is further configured to transmit the DASH segments using a dedicated ROUTE session or a private service.

3. The ATSC apparatus of claim 1,
wherein the live media stream includes the one or more markers, and
wherein the processor is further configured to:
determine whether the one or more markers match the advertisement data; and
in response to determine that the one or more markers match the advertisement data, generate the MMT packets that include the one or more markers.

4. The ATSC apparatus of claim 1, wherein the one or more markers include asset identifications (IDs) of the advertisement data and a presentation time.

5. The ATSC apparatus of claim 1, wherein the processor is further configured to:
receive a distribution window description (DWD) from the data distribution platform, wherein the DWD indicates a plurality of time locations corresponding to the advertisement data; and
transmit the DASH segments at the plurality of time locations.

6. The ATSC apparatus of claim 5,
wherein the DASH segments include geolocation information corresponding to the advertisement data, and
wherein the DWD includes the geolocation information.

7. The ATSC apparatus of claim 1,
wherein the MMT packets include a MMT package table (MPT),
wherein the MPT includes the one or more markers corresponding to the advertisement data, and
wherein the MPT indicates location information inside the receiving device and asset identifications (IDs) of the advertisement data.

8. The ATSC apparatus of claim 1,
wherein the event information is transmitted in the MMT packets and in DASH segments,
wherein the event information includes the one or more markers corresponding to the advertisement data, and
wherein the event information indicates location information inside the receiving device and asset identifications (IDs) of the advertisement data.

9. The ATSC apparatus of claim 8, wherein the event information is application event information (AEI) or inband event descriptor (IED).

10. A method of dynamic ad insertion comprising:
receiving, from a data distribution platform, advertisement data;
generating Dynamic Adaptive Streaming over HTTP (DASH) segments that include the advertisement data;
transmitting the DASH segments using a real-time object delivery over unidirectional transport (ROUTE) protocol to a receiving device;
generating a set of media processing units (MPUs) that includes live media stream corresponding to broadcast program content;
generating MPEG media transport (MMT) packets that include the set of MPUs and one or more markers corresponding to the advertisement data; and
transmitting the MMT packets using a MPEG media transport protocol (MMTP) to the receiving device,
wherein the one or more markers indicate when to insert the advertisement data into the live media stream.

11. The method of claim 10, further comprising transmitting the DASH segments using a dedicated ROUTE session or a private service.

12. The method of claim 10,
wherein the live media stream includes the one or more markers, and
wherein the method further comprises:
determining whether the one or more markers match the advertisement data; and
in response to determine that the one or more markers corresponding to the advertisement data, generating the MMT packets that include the one or more markers 13. The method of claim 10, wherein the one or more markers include asset identifications
(IDs) of the advertisement data and a presentation time.

14. The method of claim 10, further comprising:
receiving a distribution window description (DWD) from the data distribution platform, wherein the DWD indicates a plurality of time locations corresponding to the advertisement data; and
transmitting the DASH segments at the plurality of time locations.

15. The method of claim 14,
wherein the DASH segments include geolocation information corresponding to the advertisement data, and
wherein the DWD includes the geolocation information.

16. The method of claim 10,
wherein the MMT packets include a MMT package table (MPT),
wherein the MPT includes the one or more markers corresponding to the advertisement data, and
wherein the MPT indicates location information inside the receiving device and asset identifications (IDs) of the advertisement data.

17. The method of claim 10,
wherein the event information is transmitted in the MMT packets or in the DASH segments,
wherein the event information includes the one or more markers corresponding to the advertisement data, and
wherein the event information indicates location information inside the receiving device and asset identifications (IDs) of the advertisement data.

18. The method of claim 17, wherein the event information is application event information (AEI) or inband event descriptor (IED).

19. A non-transitory computer-readable device having instructions stored thereon that, when executed by at least one computing device, cause the at least one computing device to perform operations, the operations comprising:
receiving, from a data distribution platform, advertisement data;
media processing units (MPUs) generating Dynamic Adaptive Streaming over HTTP (DASH) segments based on the MPUs;
transmitting the DASH segments using a real-time object delivery over unidirectional transport (ROUTE) protocol to a receiving device;
generating a set of media processing units (MPUs) that includes live media stream corresponding to broadcast program content;
generating MPEG media transport (MMT) packets that include the set of MPUs and one or more markers corresponding to the advertisement data; and
transmitting the MMT packets using a MPEG media transport protocol (MMTP) to the receiving device,
wherein the one or more markers indicate when to insert the advertisement data into the live media stream.

20. The non-transitory computer-readable device of claim 19, wherein the operations further comprise:
receiving a distribution window description (DWD) from the data distribution platform, wherein the DWD indicates a plurality of time locations corresponding to the advertisement data; and
transmitting the DASH segments at the plurality of time locations,
wherein the DASH segments include a geolocation information corresponding to the advertisement data, and
wherein the DWD includes the geolocation information.
